(19) United States
(12) Patent Application Publication
(10) Pub. No.: US 2024/0119842 A1
(43) Pub. Date: Apr. 11, 2024

(54) Methods and Systems for Coupling Vehicles

(71) Applicant: Havenshine Technologies, Inc., Naperville, IL (US)

(72) Inventors: Ilya Sagalovich, Naperville, IL (US); Daniel Garcia, Montgomery, IL (US)

(21) Appl. No.: 18/484,103

(22) Filed: Oct. 10, 2023

Related U.S. Application Data
(60) Provisional application No. 63/414,600, filed on Oct. 10, 2022.

(51) Int. Cl. G08G 1/00; G06K 7/10; H01H 3/02

(52) U.S. Cl. CPC G08G 1/22; G06K 7/10297; H01H 3/0226; H01H 2300/026

(57) ABSTRACT

A flock of vehicles can include a leader vehicle and at least one follower vehicle coupled to the leader vehicle. In some embodiments, the leader vehicle is a lawnmower. In some embodiments, the leader vehicle can include at least one sensor. In some embodiments, the flock of vehicles operate in an inverted V-shape configuration. In some embodiments, the leader vehicle and the follower vehicle are connected via a retractable cable. In some embodiments, a sensor of the leader vehicle can detect a unique feature on a follower vehicle. In some embodiments, a drone can be coupled to a leader vehicle. In some embodiments, an autonomous vehicle can utilize a safety wire.

### CROSS-REFERENCE TO RELATED APPLICATION(S)

This application is related to and claims priority benefits from U.S. Provisional Patent Application No. 63/414,600 filed on Oct. 10, 2022, entitled “Methods and Systems for Coupling Vehicles”. The '600 application is hereby incorporated by reference herein in its entirety.

### FIELD OF THE INVENTION

The present invention relates to systems and methods for determining the position of and guiding at least partially autonomous vehicles, such as, but not limited to lawnmowers, fertilizers, agricultural tractors, mail delivery robots, snow removal machines, leaf collection machines, security surveillance robots, sports field line painting robots, land surveying equipment, and/or construction machines in outdoor environments. In some embodiments, the systems and methods can be used in boats, self-driving cars, planes, unmanned aerial vehicles, and land surveying equipment.

In some embodiments, the invention relates to coupling at least two vehicles together. In some embodiments, the invention relates to coupling a vehicle with a drone. In some embodiments, the invention relates to various safety features that can be incorporated into autonomous vehicles and semi-autonomous vehicles.

Companies are working on automating commercial grade mowers. Traditionally, either one of two technologies have been used to locate and guide autonomous vehicles in outdoor environments: real-time kinematic positioning (RTK) and simultaneous localization and mapping (SLAM).

Real-time kinematic positioning is a satellite navigation technique that enhances the accuracy of data provided by global navigation satellite systems (GNSS) such as GPS, GLONASS, Galileo, NavIC and BeiDou. Typically, the data provided by GNSS is only accurate to roughly a meter. However, RTK allows for accuracy at the centimeter level. The technique involves using a base station with a GNSS receiver located at a known location along with a rover that is free to move with its own GNSS receiver. The base station reduces the error that arises in using GNSS by comparing the difference between signals being received from multiple satellites and transmitting the relevant correction data to the rover. In some embodiments, a single base station can cover an area of up to 60 kilometers.

The second technology often used to guide autonomous vehicles, simultaneous localization and mapping, involves constructing and/or updating a map of an environment while simultaneously keeping track of the vehicle's location within the environment. Simultaneous localization and mapping can rely on merging and analyzing data obtained from lidars, stereoscopic cameras, infrared depth cameras, inertial measurement units (IMU), ultrasonic sensors, wheel encoders located on the vehicle, and/or other sensors.

SLAM algorithms often use the presence of unique features such as buildings and trees in generating their maps. SLAM algorithms can detect these features and then localize against them. The error of a SLAM-based positioning estimate increases as the distance to the mapped features increases. For example, if a camera localizes against an object 50 meters away, the accuracy of localization is significantly worse than if the camera were to localize against an object 2 meters away. Although in many instances, lidars are more accurate than cameras in measuring distance to objects located far away, the distant objects need to have sufficient reflectivity for the laser beam to reflect. In at least some embodiments, the SLAM algorithms are not affected by network delays. In at least some of these embodiments, SLAM algorithms produce fast position outputs assuming proper edge-computing hardware is utilized.

Some applications, such as US Publication No. US 2021/0364632 A1, which is incorporated by reference, discuss using an autonomous guidance system that combines the benefits of global navigation satellite systems, RTK, and a customized implementation of simultaneous localization and mapping to help map and navigate various areas, such as large fields, with autonomous vehicles such as, but not limited to lawnmowers, fertilizers, agricultural tractors, mail delivery robots, snow removal machines, leaf collection machines, security surveillance robots, sports field line painting robots, and/or construction machines. In some embodiments, older vehicles can be retrofitted to utilize the autonomous guidance system.

Lawnmowers come in various sizes. For example, lawnmowers can have deck sizes (cutting widths) between 5″ and 240″. Large commercial property owners sometimes buy mowers with decks exceeding 96″ depending on their circumstances.

However, most commercial landscapers often use mowers with decks around 60″ and only occasionally use mowers with decks around 96″. While having a larger deck can be more efficient in certain circumstances, these larger mowers often cannot be navigated in tight spaces such as between trees, between buildings, and through gates.

In addition, larger mowers often do not fit into trailers and need to be driven directly on the road at low speeds. This makes it inconvenient when a landscaper's worksites are not next to each other. In some cases, it is illegal to drive a larger mower on the road or on the highway.

Another factor against the use of mowers with larger decks is that large mowers can be expensive to buy. There is an exponential increase in the price of a machine as the deck size increases. The large price comes from the fact that these large machines are not mass produced.

What is needed is a method of automating a fleet of mowers, such that the mowers can replicate the mowing width of a larger mower, allowing for areas to be mowed more efficiently and/or quicker. There is also a need to increase the safety of autonomous vehicles and semi-autonomous vehicles, particularly on worksites that have easy public access.

### SUMMARY OF THE INVENTION

A flock of vehicles can include a first leader vehicle; a first follower vehicle, a second follower vehicle; a third follower vehicle; and/or a fourth follower vehicle. In some embodiments, the leader vehicle is coupled to at least one follower vehicle. In some embodiments, the leader vehicle is connected to at least one follower vehicle via a retractable cable.

In some embodiments, at least one of the vehicles is a lawnmower.

In some embodiments, at least one of the vehicles includes a first sensor. In some embodiments, the first sensor is used to detect a unique feature on one of the vehicles. In some embodiments, at least one of the vehicles includes a sensor that is used to detect unique features other vehicles and measure distances to these vehicles.

In some embodiments, the flock of vehicles are configured to be operated in an inverted V-shape configuration. In some embodiments, the flock of vehicles are configured to be operated in a W-shape configuration,

In some embodiments, UHF RFID technology can be used to detect vehicles in a flock and estimate distances to these vehicles. In some embodiments, the flock is configured to detect an individual using a UHF RFID tag.

In some embodiments, at least one of vehicle is coupled to a drone. In some embodiments, the drone is connected to the vehicle via a physical cord. In some embodiments, the drone is connected to the vehicle via a wireless connection. In some embodiments, the drone hovers above and/or in front of the vehicle and is drone is configured to detect an obstacle. In some embodiments, the drone has a camera.

In some embodiments, a vehicle can include a safety wire configured to stretch around the vehicle. In some embodiments, the safety wire conducts a current and is connected to a dead-man switch on the vehicle. In some embodiments, the safety wire is held together via a magnet. In some embodiments, the safety wire is configured to be electronically folded to reduce space.

### BRIEF DESCRIPTION OF THE DRAWINGS

FIG. 1 is a schematic of an autonomous vehicle utilizing various positioning technologies to navigate an outdoor environment.

FIG. 2 is a schematic of data analyzed in some embodiments of an autonomous guidance system when a reliable GNSS RTK signal is present.

FIG. 3 is a schematic of data analyzed in some embodiments of an autonomous guidance system when a GNSS RTK signal is weak or absent.

FIG. 4 is a schematic of a flock of vehicles in an inverted-v formation.

FIG. 5 is a schematic of a flock of vehicles in a w-shaped formation.

FIG. 6A is a schematic of possible paths taken by a leader vehicle and a follower vehicle in some embodiments.

FIG. 6B is a schematic of possible paths taken by a leader vehicle and a follower vehicle shown in FIG. 6A at a later point in time.

FIG. 7 is a schematic of a vehicle tethered to a drone.

FIG. 8 is a schematic of a leader vehicle identifying a follower vehicle.

FIG. 9A is a photograph taken with an infrared sensor.

FIG. 9B is a photograph of the same image of FIG. 9A taken using a traditional camera.

FIG. 9C is a graph of the point cloud data derived from analyzing FIG. 9A.

FIG. 10 is a schematic of a vehicle using a safety wire.

FIG. 11 is a schematic top view of a vehicle with an embodiment of a bumper system.

FIG. 12 is a schematic side view of a vehicle with an embodiment of a bumper system.

FIG. 13A is a schematic top view of a vehicle with an embodiment of a bumper system in a deployed configuration.

FIG. 13B is a schematic top view of a vehicle with another embodiment of a bumper system in a deployed configuration.

FIG. 13C is a schematic top view of a vehicle with another embodiment of a bumper system in a deployed configuration.

FIG. 14 is a schematic top view of a vehicle with an embodiment of a bumper system in a folded configuration.

FIG. 15 is a schematic view of a planned path for a flock of two vehicles.

FIG. 16 is a schematic view of a planned path for a flock of three vehicles.

### DETAILED DESCRIPTION OF ILLUSTRATIVE EMBODIMENT(S)

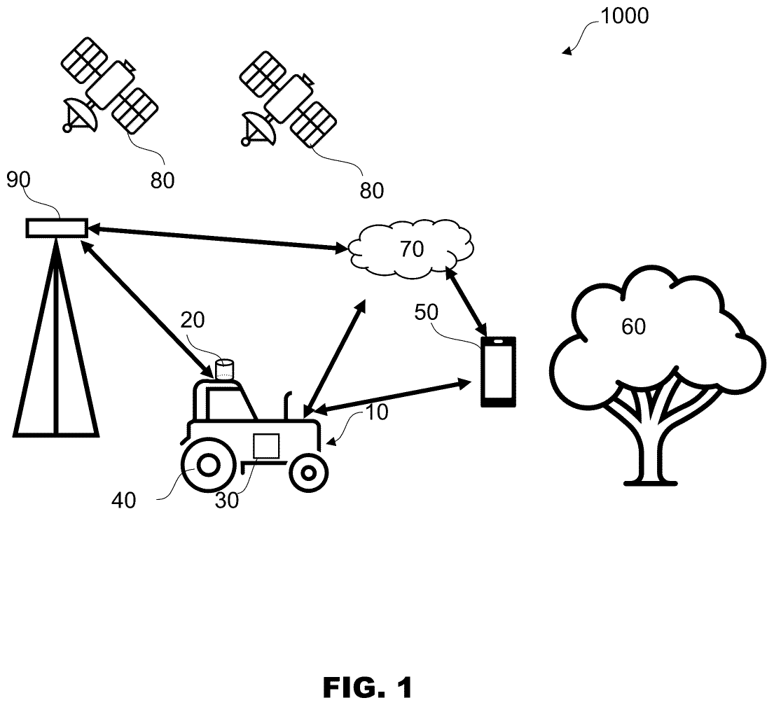

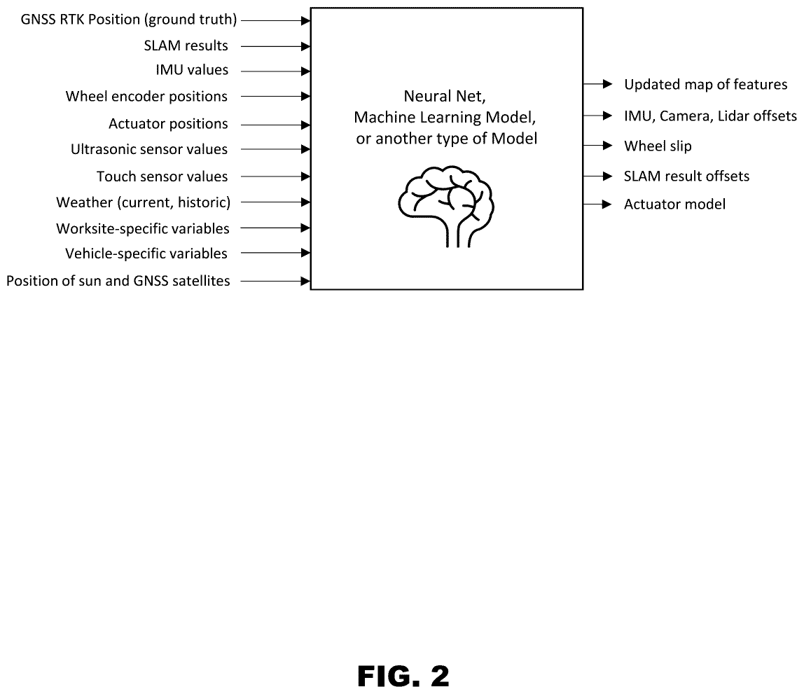

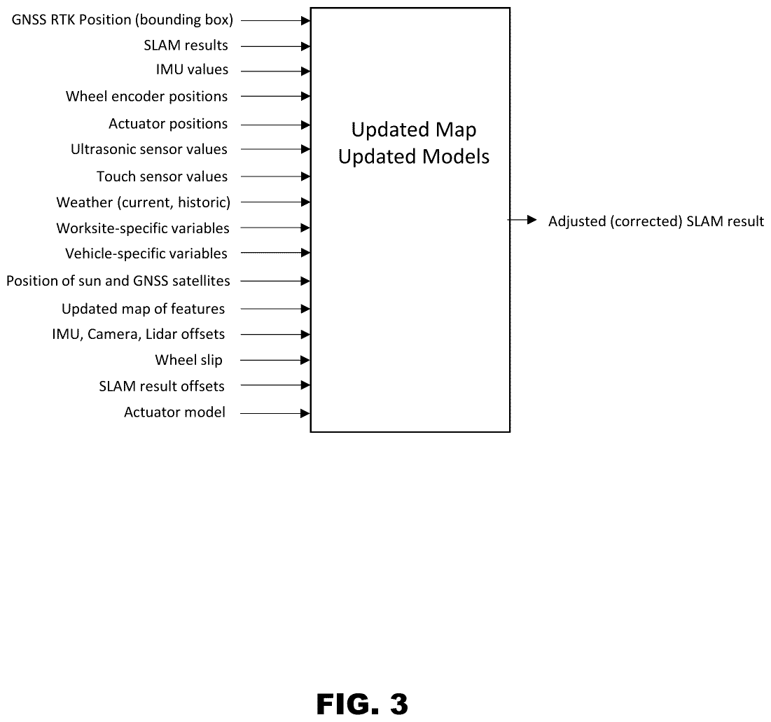

FIG. 1 illustrates autonomous guidance system 1000. In some embodiments, autonomous guidance system 1000 includes autonomous vehicle 10 utilizing both a global navigation satellite system and/or simultaneous localization and mapping to help map and navigate various areas. In some embodiments, autonomous guidance system 1000 utilizes real-time kinematic positioning.

In some embodiments, autonomous vehicle 10 is a lawnmower, fertilizer, agricultural tractor, mail delivery robot, snow removal machine, leaf collection machine, security surveillance robot, sports field line painting robot, drone, land-survey device, and/or construction machine. In some embodiments, autonomous guidance system 1000 can be utilized to retrofit an older non-autonomous vehicle and make it autonomous.

In at least some embodiments, autonomous vehicle 10 includes GNSS antenna 20. In some embodiments, GNSS antenna 20 is a RTK GNSS antenna. In some embodiments, GNSS antenna 20 communicates with at least one satellite 80. In some embodiments, GNSS antenna 20 communicates with multiple satellites 80.

In some embodiments, RTK base station 90 is used. In some embodiments, RTK base station 90 communicates with at least one satellite 80. In some embodiments, RTK base station 90 communicates with multiple satellites 80.

In at least some embodiments, autonomous vehicle 10 includes at least one SLAM component 30. In at least some embodiments, SLAM component 30 collects data that can be used to build a map of the surrounding area and/or navigate autonomous vehicle 10 through the same. In some embodiments, SLAM component 30 can be, among other things, a camera, a lidar, an IMU, a downward facing sensor to detect height and/or texture differences and/or an ultrasonic sensor. In some embodiments, SLAM component 30 is an impact sensing bumper. In some embodiments, SLAM component 30 is an encoder installed on the wheel of a vehicle. In some embodiments, SLAM component 30 is a signal/command applied to the actuators of autonomous vehicle 10.

In FIG. 1 feature 60 (shown as a tree) can be used by the simultaneous localization and mapping system in generating a map and navigating autonomous vehicle 10. In some embodiments, feature 60 can obstruct the signal coming from satellite 80. In some embodiments, feature 60 can change over time.

In at least some embodiments, autonomous vehicle 10 includes at least one wheel encoder 40. In some embodiments, wheel encoder 40 measures the angular position of the wheel. In some embodiments, autonomous vehicle 10 includes multiple wheel encoders 40. In some embodiments, autonomous guidance system 1000 compares data from multiple wheel encoders 40.

In at least some embodiments, data from at least one SLAM component 30, at least one wheel encoder 40, GNSS antenna 20, autonomous vehicle 10, base station 90, and/or satellite 80 can be transmitted to server 70 to be analyzed and/or manipulated. In some embodiments, server 70 is located on site. In some embodiments, server 70 is in the cloud. In some embodiments this data is used to calculate various factors such as, but not limited to, IMU calibration, errors, and/or misalignment, camera calibration errors, camera misalignments, and/or lidar misalignments.

In some embodiments, autonomous vehicle 10 captures at least one of the following parameters and uploads them to server 70: RTK position estimate (result and quality of estimate); SLAM position estimate (result and quality of estimate); images captured by SLAM cameras and/or lidars; raw IMU values such as those coming from an accelerometer, gyroscope, and/or magnetometer; raw wheel encoder values (exact wheel position); raw ultrasonic sensor values; raw values captured by downward facing sensors; impact sensing bumper and/or steering actuator values and/or motion actuator values.

In some embodiments, RTK data, such as a RTK calculated position is used to calibrate SLAM components such as, but not limited to, lidars, stereoscopic cameras, infrared depth cameras, IMUs, ultrasonic sensors, and/or wheel encoders. In some embodiments, this resulting calibration can be used to adjust the SLAM-based position estimate when GNSS signals are not available. In some embodiments, once the model is created and calibrated, it can be used with vehicles that do not have RTK receivers and/or SLAM components.

In some embodiments, when the autonomous guidance system 1000 is receiving consistent and reliable GNSS signals and there are unique features that can be seen by at least one SLAM component, a strong RTK position estimate (RTK fix) and a strong SLAM position estimate can be determined. This often occurs when the unique features are easily detected by SLAM components, but these features do not block the sky. Examples of such features include, but are not limited to, mailboxes, power boxes, chairs, other vehicles, and small bushes. These features allow SLAM algorithm(s) to give a position result with a level of confidence. At the same time, since the sky view is clear, GNSS RTK can provide reliable data. In at least some embodiments, the algorithm(s) can take the GNSS RTK result to be the ground truth and use it to compute the “error” in the SLAM position estimates. In some embodiments, this “error” can then be used in the exact same location when GNSS RTK signal is temporarily unavailable due to a temporary problem such as network delays.

In some embodiments, even when the RTK signal is strong (RTK fix), the system can utilize SLAM components, such as IMU and wheel encoders, to give intermediate positions. In some embodiments, this is done because of the large latency in the position computed based on GNSS-RTK. So, for example, in some embodiments, if the vehicle hits a bump and this bump causes the path to change, then the IMU and wheel encoders can sense the change in path up to 1 second earlier than the RTK receiver. This means that the closed-loop control system can start responding up to 1 second quicker and keep the vehicle on a straight, or at least straighter line.

SLAM position estimates can be incorrect due to numerous factors such as, but not limited to, changing features (e.g., growing bushes and trees) and/or camera-specific limitations, such as lens geometry.

In at least some embodiments, wheel encoders 40 are not sufficient to accurately calculate the position of autonomous vehicle 10. In at least some embodiments, this can be due to, among other things, wheel slip. Wheel slip can be a function of multiple variables, including, but not limited to, the size, age, and/or material of the wheel, air pressure in the wheel, the weight of autonomous vehicle 10, how wet the surface is (based on direct measurements and/or on historical weather patterns such as recent rainfall), the type of surface (such as asphalt, grass, dirt, etc.), and/or the incline of the surface.

In some embodiments, autonomous guidance system 1000 records the values applied to the actuators as the vehicle moves from one point to another. In at least some embodiments, during an initial run over a new area, autonomous guidance system 1000 relies on a closed-loop control system to produce the actuation values. On a future run the autonomous guidance system 1000 uses the calculated values as “feed-forward” control values to decrease the error of the vehicle. In some embodiments, the autonomous guidance system 1000 calculates new actuation values which can act as “feed-forward” control values for future runs. Overtime, these “feed-forward” control values improve efficiency and/or performance of the vehicle. In some embodiments, the use of location-specific feed-forward actuation values allow the closed-loop correction values to be small. In some embodiments, small correction values are about 5% (or lower) of the entire motion range of the actuators. In at least some embodiments, this leads to smooth and stable navigation.

In the above example, there can be many factors which contribute to the need for “feed-forward” control values to improve performance, including, but not limited to, that the vehicle may be operating on a slope, the vehicle may be hitting a hole or some sort of bump along the path, changing pressure in tires, and/or a given motor is getting old and requires more power to operate. In some embodiments, tire deflation can be detected based on changes in the actuator values for a given location.

In at least some embodiments, slopes, holes, and bumps can be identified with an IMU. In at least some embodiments, IMUs contain inclinometers which can sense the tilt of the vehicle with respect to the horizon. In some embodiments, autonomous guidance system 1000 can use this tilt to perform corrections before the error can accumulate. In some embodiments, to determine how much correction is needed, a model which correlates vehicle tilt with the power required for the actuators to keep the vehicle moving straight can be calculated and then utilized in future runs.

Environmental factors, such as, but not limited to, grass height, weather, precipitation, and wind can be considered when building the model. In some embodiments, multiple models can be built for a given area and utilized based on the given conditions of a particular run. In some embodiments, the current environmental conditions can be determined via SLAM sensors, a humidity sensor, or utilizing data generated from an independent source, such as weather data provided from a third party. In some embodiments, the height of grass can be determined using sensors installed on the vehicle, such as an IR camera.

In some embodiments, autonomous guidance system 1000 can use the calculated models when a RTK signal is not present or is poor (due to obstructions or network delays/outages). In some such embodiments, the autonomous guidance system 1000 can also use data from a magnetometer, an accelerometer, the positions of wheel encoders, and/or patterns detected on the ground to determine the heading and position of the vehicle. In some embodiments, a 3D lidar can be used to approximate the position.

In at least some embodiments, IMUs alone are not sufficient to accurately estimate the position of autonomous vehicle 10. In some embodiments, the position reported by an IMU drifts over time due to the accumulation of inertial errors.

Similarly, in at least some embodiments, lidars and/or cameras are susceptible to errors resulting from, among other things, accuracy limitations of equipment, localizing against features too far away, localizing against features which change overtime, camera, lidar, and/or IMU misalignments, and/or sunlight blinding the sensors. Furthermore, when localizing against changing landscapes, such as bushes or trees, cameras and lidars can have a slow drift in the computed position.

In some embodiments, by collecting data related to parameters which affect wheel slip, IMU measurements, and other SLAM components, autonomous guidance system 1000 can generate a model that predicts how large the various component errors are and the direction of these errors. This model can then be compared and adjusted with data coming from the GNSS signals.

In at least some embodiments, the GNSS RTK derived computed error can be used to adjust the map used in SLAM localization. In some embodiments, the computed error can be used in a model which can estimate the camera-lens inaccuracies. In at least some embodiments, once a model is built and calibrated, it can be used to accurately compute positions of a vehicle in places where GNSS signals are not available and/or temporarily absent. The error estimates computed by the model can be applied to the values generated by SLAM components (wheel encoders, IMUs, cameras, and lidars) to compute an accurate position which accounts for the errors.

In some embodiments, the computed error, and its direction, can be used to detect if one of the SLAM components, such as a camera or IMU, is unaligned with the vehicle's direction. In at least some embodiments, this allows for computing of an offset which is later used in position determination.

In some embodiments, when autonomous vehicle 10 moves to an area where the GNSS signal is weak, for example near a large tree or close to a building, it can detect some of the same features, such as power boxes and bushes. But the autonomous guidance system 1000 now knows the “correct” locations of these objects via the GNSS RTK derived map. In some embodiments, autonomous guidance system 1000 can create a model which considers camera-lens inaccuracies and camera/IMU misalignments. In some embodiments, the updated map, in combination with the “error models” for the SLAM components, can be used to give an improved SLAM position estimate in the areas where the RTK signal is weak and/or temporarily absent.

In some embodiments, RTK can be used to compute the heading of the vehicle. In at least some embodiments, the measured heading is in degrees from true north. In at least some embodiments, it is beneficial for several reasons including the fact that Earth's magnetic pole is about 1000 miles south of the true north pole and is continuously shifting and, as such, magnetic north is not true north. In addition, in at least some instances, magnetic compasses are susceptible to electromagnetic interference from nearby components such as, but not limited to, electrical motors.

In some embodiments, data from a magnetometer, which is often found in many IMUs is not accurate (for the reasons discussed above). However, this data comes at a faster speed than RTK data. As a result, in some embodiments, autonomous guidance system 1000 can use the magnetometer data to get intermediate heading estimates. In some embodiments, autonomous guidance system 1000 can determine the error in the magnetometer data by comparing it to the GNSS RTK data. The calculated error can be used to recalibrate the magnetometer data. In some embodiments, the autonomous guidance system 1000 can determine the error for different parts of a map. These errors can then be taken into account depending on where the vehicle is located. In some embodiments, the error calculation can be used during outages of GNSS RTK to get approximate heading estimates. In some embodiments, it can be used to get faster heading readings while waiting for GNSS RTK data.

In one method for determining a heading, a GNSS RTK receiver is installed at the front of a vehicle. As the vehicle performs a zero-degree turn, the GNSS RTK receiver moves along the circumference of a circle. By rotating the vehicle by a given angle, it is possible to capture positions along the circumference of the circle. These positions can then be used to compute an equation for the circle and find the center of the circle. The heading of the vehicle can then be computed as the heading from the center of the circle to the current position of the GNSS RTK receiver. This computed heading is significantly more accurate than the heading obtained with a magnetic compass.

In some instances, during a zero-point turn, the motion of the RTK receiver may not be along a perfect circle. This often happens when the forward direction of one wheel is faster than the reverse direction of the other wheel. When this happens, an adjustment can be made when computing the center of the circle.

A second method for determining a heading involves moving the vehicle straight for a given distance (for example several centimeters) on a flat surface. By comparing the GNSS RTK positions of the vehicle before the move and after the move, the computer on the vehicle can determine its heading.

Once the heading is known, it can be updated during consecutive turns and during linear travel. In at least some embodiments, the heading can also be used to navigate a geospatial path.

In at least some embodiments, having both position and heading results from both GNSS and simultaneous localization and mapping, allows autonomous guidance system 1000 to calculate a coordinate system transform for both frames of reference. In other words, both real-time kinematic positioning and simultaneous localization and mapping solutions can be transformed to provide position and heading measurements with respect to a predetermined frame of reference.

Once both solutions are transformed to the same frame of reference, RTK data can be used to calibrate the SLAM components. For example, if SLAM cameras, IMUs, and/or lidars are misaligned and are pointing in the wrong direction, RTK data can be used to detect this misalignment and compute the degree by which the components are misaligned. This information can then be used in the calculation of the coordinate transform to “virtually re-align” the SLAM components.

In some embodiments, when performing SLAM computations, the actuation values of autonomous vehicle 10, such as its steering angle and power applied to its actuators (voltage and current), can be considered.

In some embodiments, the SLAM computation can use the GNSS RTK signal even when the signal is weak. In at least some of these cases, the GNSS RTK signal is not used as the ground truth but instead used to confine/restrict the SLAM result to a given area, such as a 5-meter circle. By confining the SLAM result, the localization process can be quickened.

In some embodiments, simultaneous localization and mapping can localize using a feature, such as a bush, that changes with time. In some of these embodiments, the SLAM components give false position estimates due to the changing feature. By transforming RTK and SLAM solutions into the same frame of reference, it is possible to compute how the features change overtime and adjust the SLAM position estimates.

In some embodiments, the rate at which the feature, such as a tree, bush, and/or crop grows is a useful metric which can be uploaded to server 70 in autonomous guidance system 1000 and used in other applications.

In some embodiments, autonomous guidance system 1000 is configured to be utilized when certain features change throughout the year. For example, in some embodiments, autonomous guidance system 1000 is configured to compensate for when deciduous trees drop their leaves.

In some embodiments, autonomous guidance system 1000 can be run when leaves are not on the trees. In some embodiments, this allows autonomous guidance system 1000 to receive more accurate and reliable information from satellite(s) 80. In some embodiments, a user could initially map an area when leaves are not on the trees. In some embodiments, this allows autonomous guidance system 1000 to generate a calibration for the model even in places where a GNSS signal is normally too weak to obtain a good position estimate and/or a good estimate for the positions of surrounding objects. In at least some of these embodiments, once the leaves on the trees re-appear, the calibrated model can be used to compute accurate positions which account for errors of the SLAM components and use the pre-estimated positions of surrounding objects.

In some embodiments, combining GNSS with SLAM components provides greater cyber security of system 1000. For example, hackers have been known to hijack GNSS RTK signals and then send false satellite positions and confuse the GNSS receiver into obtaining incorrect position estimates. A system 1000 utilizing SLAM components in conjunction with GNSS signals is more likely to detect that the signal has been hijacked as the system could compare the GNSS calculated position with the position estimated by the SLAM components.

### Using a Transform to Improve GNSS RTK Position Estimates

In some embodiments, autonomous guidance system 1000 can take into account the fact that data arriving from certain SLAM components can be compromised due to the position of the SLAM component.

For example, when operating on an incline, or when encountering a hole in the ground, the RTK position estimate does not reflect the true position of the vehicle (the center between the vehicle wheels). In embodiments where the RTK antenna is located at the top of the vehicle, the difference can be magnified. The issue can be partially mitigated by placing the antenna closer to the ground. However, in some embodiments, this may not be possible and/or recommended because it would then introduce noise (obstructions and ground noise) for the GNSS RTK signal.

In some embodiments, autonomous guidance system 1000 determines the tilt of the vehicle, such as from an IMU and uses the tilt angle to compute the offset between the RTK position and the real position of the vehicle. In some embodiments, the system takes into account the time difference between the tilt data arriving from the IMU and the GNSS RTK data.

Uses of Mobile Devices with Autonomous Guidance Systems

As mentioned above, various devices such as mobile devices, including, but not limited to, smartphones, tablets, laptops, and the like, can be used with autonomous guidance system 1000. In some embodiments, mobile device 50 is designed specifically to work with autonomous guidance system 1000. In some embodiments, mobile device 50 is a traditional mobile device, such as a smartphone or tablet, that can be retrofitted, either via software such as a downloadable application and/or additional pieces of hardware, to work with autonomous guidance system 1000.

In some embodiments, a mobile device can be used as an emergency stop switch “E-STOP switch”. In some embodiments, an operator can shut down one or more autonomous vehicles via said E-STOP-switch. In some embodiments, the operator is on site. In some embodiments, the operator is at a remote location.

In some embodiments, the E-STOP-switch utilizes a long-range radio as a way of sending a stop signal from transmitter to receiver.

In some preferred embodiments, autonomous guidance system 1000 uses an internet-connected mobile device as a way of communicating with the autonomous vehicle, such as commanding an emergency stop.

In some embodiments, an application running on a mobile device can regularly send “run” commands to a server and monitor for physical button presses. In some embodiments, if a button is pressed on the mobile device, such as home button, volume up, or volume down, the application can send a “stop” command to a server and then will stop transmitting messages. In some embodiments, by running as a foreground service, the application can continue to work even when the screen is turned off and the mobile device is put away, such as in an operator's pocket.

In some embodiments, a wireless communications protocol, such as Bluetooth, Wi-Fi, CDMA, 900 MHz, 3G/4G/5G/Cellular, near-field communication, and/or other communication protocol is used to send a stop signal from a stop switch to the mobile device. In some embodiments, this allows the switch to be in an easily accessible location such as on the belt or on the hand of the operator. In some embodiments, there is a hard-wired digital interface between the switch and the phone. In some embodiments, this allows the switch to send commands over the digital interface. In some embodiments, the switch can contain at least one button. In some embodiments, the switch can contain at least two buttons. In some embodiments, a first button can be used to pause operation of one or more autonomous vehicles and a second button can be used to completely stop operation of one or more autonomous vehicles.

In some embodiments, the switch can interrupt the power coming from a portable battery. In some embodiments, the application monitors whether the mobile device is connected to the battery. In some embodiments, when the mobile device is disconnected from the battery, a stop command is sent to the vehicle. In at least some embodiments, an external portable battery is useful to prevent the mobile device from discharging and shutting off in the middle of an autonomous run. In at least some embodiments, the above setup allows for compatibility across different mobile devices. In some embodiments, the switch can be located on the battery itself. In some embodiments, the battery can be plugged directly into the mobile device. In some embodiments, a cable is used to connect the battery to the mobile device. In some embodiments, the switch includes an indicator to show its state (ON/OFF). In some embodiments, the indicator is an LED. In some embodiments, the indicator is a plurality of LEDs.

In some embodiments, the switch is a physical button. In some embodiments, the switch can be a magnetically coupled connector which can be disconnected by pulling on the cable.

In some embodiments, mobile devices can be used with autonomous guidance system 1000 to geofence in one or more autonomous vehicles. In some embodiments, by comparing the GPS geolocation of the mobile device with the geolocation of the vehicle, it is possible to know how far away the mobile device is from the vehicle. In some embodiments, this allows autonomous guidance system 1000, often through an application, to set a precise distance from the mobile device at which point the vehicle should stop.

In some embodiments, this allows autonomous guidance system 1000 to compare the location of a mobile device to the location of the pre-planned worksite. In some embodiments, when the mobile device gets a predetermined distance from a worksite, one or more autonomous vehicles will automatically come to a stop. In some embodiments, the feature prevents, or at least reduces the chance that vehicles will continue operating autonomously when the operator leaves the worksite. This can be beneficial if the operator unexpectedly and/or suddenly leaves the worksite.

In some embodiments, autonomous guidance system 1000 can be configured such that if the geolocation of the operator (as determined via the mobile device) is too close the geolocation of the autonomous vehicle, the vehicle can automatically come to a stop to prevent an accidental collision with the operator. In some embodiments, autonomous guidance system 1000 can be configured such that if the geolocation of the operator (as determined via the mobile device) is close to the geolocation of the autonomous vehicle, the vehicle can avoid the operator. In some embodiments, the autonomous guidance system 1000 can be configured such that the autonomous vehicle can be recalled to the operator using the geolocation of the operator (as determined via the mobile device).

In some embodiments, the mobile device can periodically (for example, every 15 minutes), show a notification to the operator to remind the operator to keep an eye on the autonomous vehicle. In some embodiments, if the operator does not respond to the notification by performing a certain action, such as pressing a button, then the autonomous vehicle can be configured to stop.

In some embodiments, a receiver on the vehicle constantly checks for periodic “run” commands from the mobile device. In some embodiments, the receiver can expect to receive commands at given time intervals (such as least once per second). In some embodiments, the receiver can be configured to check the message timestamp to ensure that it does not, or at least reduce the chance that it does, process old commands. In some embodiments, when the receiver does not receive run commands for more than a second, the receiver stops the vehicle.

In some embodiments, the receiver can contain multiple SIM cards from different internet service providers. In some embodiments, this offers failover redundancy which helps mitigate issues related to an outage of a single internet service provider.

In some embodiments, “run” and “stop” commands can be transmitted to several servers simultaneously. In some embodiments, these servers can be managed by third-party cloud service providers. In some embodiments, when one provider experiences an outage, the other provider will communicate the messages. In at least some embodiments, by sending the commands to multiple servers, the receiver can check whether one of the servers was illegitimately accessed i.e., hacked. For example, if one server is transmitting “run” commands and the other is transmitting “stop” commands, then the receiver will know that something is wrong and stop the vehicle.

In some embodiments, a Virtual Private Network (VPN) runs on the mobile device. In some embodiments, there is a strict protocol for granting the application access to the servers (such as multi-factor authentication). In some embodiments, to connect to a vehicle, a user will need to turn on a physical switch on a vehicle. In some embodiments, pairing can be enabled for just a few seconds after the switch is turned on. In some embodiments, the receiver in the vehicle can generate a unique token (access code) which the application must transmit in future requests.

While autonomous vehicles can use sensors to detect obstacles and guide themselves around an area, when vehicles operate close to trees, buildings, and other obstacles, people can be present behind these obstacles. As a result, on-board sensors on the vehicles may not detect these individuals.

Furthermore, there are times when objects, such as grass clippings, dust, snow, or ice, block on-board sensors, making it difficult for the on-board sensors to see the surroundings. Also, sometimes people and animals may be present inside tall grass, making it difficult for on-board sensors to detect them.

To enable unsupervised truly-autonomous operations, in at least some embodiments, it is necessary to detect people before they approach the autonomous vehicle and/or the autonomous vehicle approaches them. To aid in this detection, in some embodiments, individuals in the vicinity of vehicles, such as vehicle 202, can provide information regarding their position to a leader vehicle and/or a follower vehicle. In some embodiments, this is done via an individual sharing their phone's GPS position with the vehicle so that they can be detected by the vehicle even if the vehicle's sensors fail to pick them up. The sharing of an individual's position can also be accomplished by other means, including but not limited to, UHF RFID tags, LoRa radio, UWB, and/or or other technologies. In some embodiments, where a vehicle operates on a fenced worksite, individuals who enter the worksite can have badges equipped with devices that generate signals that can be detected by the vehicle.

In some embodiments, it is possible to place sensors near the entrance of worksites, that can detect an individual. The information can be shared with the vehicles to alert them that an individual has entered the worksite. In some embodiments, these sensors can be incorporated into warning signs. In some embodiments, when security-cameras are present on the worksite, the location of individuals detected by the security cameras can be shared with the vehicles.

In some embodiments, when multiple vehicles are operating at the same worksite, they can share data with each other regarding people on the worksite and/or other obstructions.

In some embodiments, if an individual uses an emergency-stop switch to supervise autonomous operations, this switch can send its position to the autonomous vehicle. For example, in some embodiments, the E-stop switch can be equipped with a GPS receiver, or with a device that generates signals. In some instances when GPS is utilized, a signal can be sent to the autonomous vehicle, which can then compare its own GPS location to that of the E-stop switch. In some instances when a generated signal is used, this signal can be detected by the vehicle to approximate distance to the E-stop switch. In some embodiments, this allows the vehicle to slow down when the individual gets within a certain distance to the vehicle. In some embodiments, the vehicle(s) can stop when an individual operator gets within a certain distance to the vehicle. In some embodiments, the vehicle(s) can stop if a particular individual, such as an operator, gets too far. This can, for example, happen if the operator suddenly had to leave the worksite.

Coupling Vehicles into Flocks

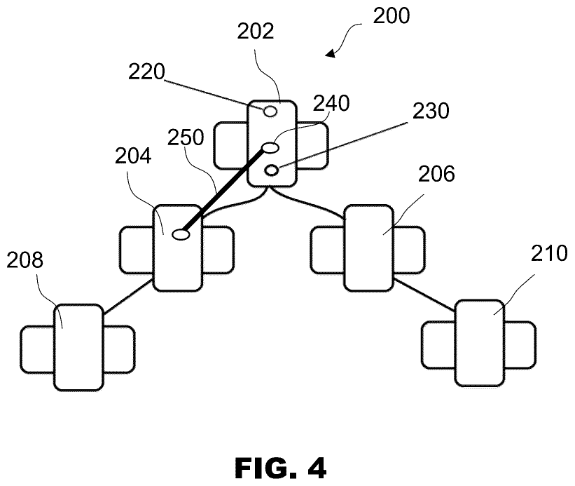

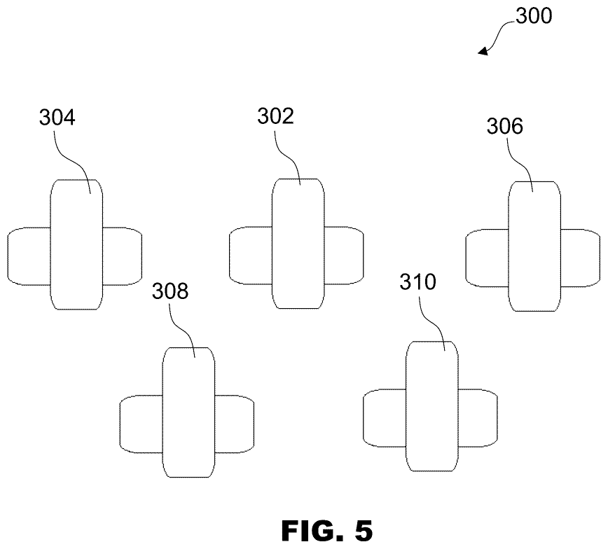

Using a flock of vehicles, such as shown in FIG. 4 and FIG. 5 can allow for smaller vehicles, such as mowers with smaller decks, to be coupled together to essentially replicate the size of larger vehicles. In some embodiments, this is more efficient as the smaller vehicles are cheaper, easier to transport, and/or more adaptable than a single large vehicle. In some embodiments, smaller machines can be used in worksites that have tight spaces between trees, buildings, or other obstacles.

When dealing with autonomous and semi-autonomous setups, using flock setups can help reduce the need of expensive GPU-equipped computers, GNSS systems, lidars, or other high-end sensors on each vehicle, as often only one vehicle needs to have the equipment installed.

FIG. 4 illustrates a schematic of flock 200 including leader vehicle 202, follower vehicle 204, follower vehicle 206, follower vehicle 208 and follower vehicle 210. In the embodiment shown, leader vehicle 202 is located at the center of flock 200. In some embodiments, a flock can include more than one leader vehicle.

In some embodiments, leader vehicle 202 includes GNSS 220 and/or at least one sensor 230. In some embodiments, sensor 230 is a lidar sensor, camera and/or a radar sensor.

FIG. 4 shows flock 200 in an inverted-V-shape configuration. In some embodiments, each vehicle is given the space to move a little bit left and right while still having sufficient cutting deck overlap and preventing the vehicles from colliding with each other. In some embodiments of an inverted-V-shape configuration, there is one leader vehicle 202 in the front and several follower vehicles in the back.

Other flock configurations are possible. For example, FIG. 5 shows flock 300 in a W-shape configuration. In some embodiments of a W-shape configuration, one leader vehicle 302 is in the middle, two follower vehicles 304 and 306 are on each side of leader vehicle 302, and two additional follower vehicles 308 and 310 are in the back.

In some embodiments, three-vehicle flocks are used. In some embodiments, seven-vehicle flocks are used. Other flock configurations are possible including flocks with an even number of vehicles. In some embodiments, flocks with several leader vehicles are utilized.

In some embodiments, leader vehicle 202 is an autonomous vehicle. In some embodiments, leader vehicle 202 is a semi-autonomous vehicle. In some embodiments, follower vehicle 204, follower vehicle 206, follower vehicle 208 and/or follower vehicle 210 are autonomous vehicles.

In some embodiments, leader vehicle 202 is semi-autonomous. In some embodiments, leader vehicle 202 is completely manual. In some embodiments, leader vehicle 202 can be operated by an individual or group of individuals, such as a professional landscaper. In some embodiments, the individual(s) are responsible for the navigation and/or safety of the vehicle(s). In some embodiments, the individual(s) can check for people, animals, potholes, standing water, and/or other obstacles around and ahead of flock 200. In at least some embodiments, when a leader vehicle is manually operated by an onboard operator, it can help decrease the likelihood of an accident. This type of operation may also be required under certain circumstances, such as when the vehicles are operated in congested and/or public areas. Having an onboard operator also helps reduce, if not eliminates, failed stops due to false negatives that can be the result of sensor and/or software issues.

In some embodiments, leader vehicle 202 can be semi-autonomous. In some embodiments, leader vehicle 202 has at least one navigation system and/or at least one safety system. In some embodiments, leader vehicle 202 has a plurality of safety systems.

In some embodiments, such as when leader vehicle 202 is semi-autonomous, it can be operated by an untrained individual. In some embodiments, this individual acts as an observer and sits on leader vehicle 202 and can stop flock 200 if they detect an obstacle and/or danger. In some embodiments, leader vehicle 202 can be stopped and/or shutdown via an emergency stop switch. In some embodiments, the emergency stop switch can be wired into the existing controls of leader vehicle 202. For example, in some embodiments, the stop can be commanded through the activation of a seat switch (dead man switch) and/or through the activation of a lap bar safety switch.

The ability to use an individual that does not need to know how to fully operate leader vehicle 202, due to its semi-autonomous nature, can be a cost saving feature as the individual does not need to be as highly trained.

In some embodiments, leader vehicle 202 is manual and is operated by a trained operator who is responsible for navigation of leader vehicle 202 and for the safety of flock 200. In some of these embodiments, follower vehicles can be equipped with their own GNSS-RTK-based navigation systems. In some embodiments, the emergency stop switch for flock 200 can be wired into the lap bar switch or into the seat switch (dead man switch) of leader vehicle 202. In some embodiments, leader vehicle 202 is fully autonomous. In some embodiments, the fully autonomous vehicle is supervised at a distance by an individual with an emergency stop switch. In some embodiments, leader vehicle 202 can operate without onsite human supervision.

In some embodiments, follower vehicle 204, follower vehicle 206, follower vehicle 208 and/or follower vehicle 210 do not have any navigation systems and/or safety systems. In some such embodiments, follower vehicle 204, follower vehicle 206, follower vehicle 208 and/or follower vehicle 210 receive speed and/or steering commands from leader vehicle 202. In some embodiments blade speed and/or cutting-deck height of the flock can be controlled by the leader vehicle.

In some embodiments, follower vehicle 204, follower vehicle 206, follower vehicle 208 and/or follower vehicle 210 can be semi-autonomous. In some such embodiments, follower vehicle 204, follower vehicle 206, follower vehicle 208 and/or follower vehicle 210 are equipped with navigation system(s) that allows them to determine their own position(s) and navigate autonomously. In some embodiments, follower vehicle 204, follower vehicle 206, follower vehicle 208 and/or follower vehicle 210 follow leader vehicle 202. In some embodiments, the safety of follower vehicle 204, follower vehicle 206, follower vehicle 208 and/or follower vehicle 210 is monitored by leader vehicle 202.

In some embodiments, follower vehicle 204, follower vehicle 206, follower vehicle 208 and/or follower vehicle 210 are equipped with at least one safety system. In some embodiments, the safety system detects the presence of people and/or large objects. In some embodiments, follower vehicle 204, follower vehicle 206, follower vehicle 208 and/or follower vehicle 210 do not need to independently detect various features, such as but not limited to, small objects, wet ground, and/or obstacles. In some embodiments, leader vehicle 202 provides information about these features to follower vehicle 204, follower vehicle 206, follower vehicle 208 and/or follower vehicle 210.

In some embodiments, such as shown in FIG. 4, leader vehicle 202 is configured to go in front of follower vehicle 204, follower vehicle 206, follower vehicle 208 and/or follower vehicle 210.

In some embodiments, leader vehicle 202 is connected to follower vehicle 204, follower vehicle 206, follower vehicle 208 and/or follower vehicle 210 by a connection. In some embodiments, the connection is physical retractable cable 250, such as, but not limited to a high-speed data cable. In some embodiments, the connection is a short-range high-speed wireless communication. In some embodiments, the connection is a cloud connection. In some embodiments, leader vehicle 202 is connected to follower vehicle 204, follower vehicle 206, follower vehicle 208 and/or follower vehicle 210 by multiple connections, such as but not limited to, physical retractable cable 250, a short-range high-speed wireless communication, and/or a cloud connection.

In at least some embodiments, if leader vehicle 202 is fully autonomous, the sensors and/or cameras on leader vehicle 202 provide 360° of coverage. This helps ensure, or at least increase the likelihood, that leader vehicle 202 is aware of possible obstructions, dangers, or living objects. In some embodiments, leader vehicle 202 can help ensure the safety of follower vehicles.

In some embodiments, leader vehicle 202 is able to determine the position of follower vehicle 204, follower vehicle 206, follower vehicle 208 and/or follower vehicle 210.

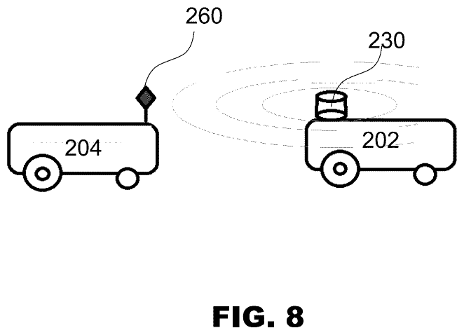

In some embodiments, such as shown in FIG. 8, leader vehicle 202 is able to determine the position of the follower vehicles using a wireless (non-contact sensor) position determination. In some embodiments, leader vehicle 202 uses at least one lidar sensor that detects follower vehicle 204, follower vehicle 206, follower vehicle 208 and/or follower vehicle 210. In some embodiments, follower vehicle 204, follower vehicle 206, follower vehicle 208 and/or follower vehicle 210 contain at least one unique feature 260 that can be detected by leader vehicle 202. In some embodiments, unique feature 260 is a special shape and/or bracket mounted to follower vehicle 204, follower vehicle 206, follower vehicle 208 and/or follower vehicle 210. In some embodiments, point-cloud data generated by the lidar can be processed to detect the exact location of this bracket.

In some embodiments, the follower vehicles can use on-board sensors, such as radar(s) or camera(s), to detect the position of leader vehicle 202.

In some embodiments, leader vehicle 202 uses at least one stereoscopic camera installed on leader vehicle 202 that can detect a unique feature, barcode and/or QR code on follower vehicle 204, follower vehicle 206, follower vehicle 208 and/or follower vehicle 210.

In some embodiments, leader vehicle 202 has at least one ultrasonic sensor and/or radar sensor installed on leader vehicle 202 that can detect unique feature 260, barcode and/or QR code on follower vehicle 204, follower vehicle 206, follower vehicle 208 and/or follower vehicle 210.

In some embodiments, leader vehicle 202 uses at least one short-range radio signal, such as but not limited to ultra-wideband technology, installed on leader vehicle 202 to estimate the position of follower vehicle 204, follower vehicle 206, follower vehicle 208 and/or follower vehicle 210.

In some embodiments, leader vehicle 202 uses a retractable mechanism, such as cable 250, that is connected between leader vehicle 202 and follower vehicle 204, follower vehicle 206, follower vehicle 208 and/or follower vehicle 210. In some embodiments, leader vehicle 202 measures the length to which cable 250 is stretched and the angle at which cable 250 is pointing. Using this length and angle, leader vehicle 202 can compute the position of the follower vehicle.

In some embodiments, leader vehicle 202 utilizes digital protractor 240 with a built-in spinning mechanism and/or a digital protractor that uses an IMU (inertial measurement) and sits on top a freely spinning circular base plate (such as a turntable bearing) to measure the angle between leader vehicle 202 and follower vehicle 204, follower vehicle 206, follower vehicle 208 and/or follower vehicle 210.

In some embodiments, cable 250 connecting leader vehicle 202 with follower vehicle 204, follower vehicle 206, follower vehicle 208 and/or follower vehicle 210 can be magnetically mounted to leader vehicle 202 and/or follower vehicle 204, follower vehicle 206, follower vehicle 208 and/or follower vehicle 210. One advantage of using a magnetically mounted cable is that it can disconnect without damaging cable 250 or the vehicles.

In some embodiments, follower vehicle 204, follower vehicle 206, follower vehicle 208 and/or follower vehicle 210 can be equipped with at least one sensor to detect leader vehicle 202 and/or other follower vehicles. In some embodiments, the sensor can be, but is not limited to, a lidar sensor, radar sensor, and/or digital protractor.

In some embodiments, if any of the connected vehicles in flock 200 experience a connection issue, all the vehicles in flock 200 can be configured to stop.

In some embodiments, if any of the connected vehicles in flock 200 move past a given distance from a given vehicle, then all the vehicles in flock 200 can be configured to stop.

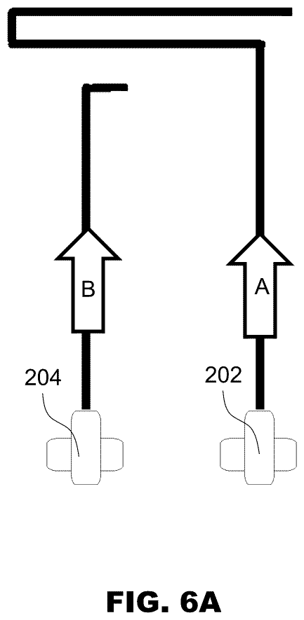

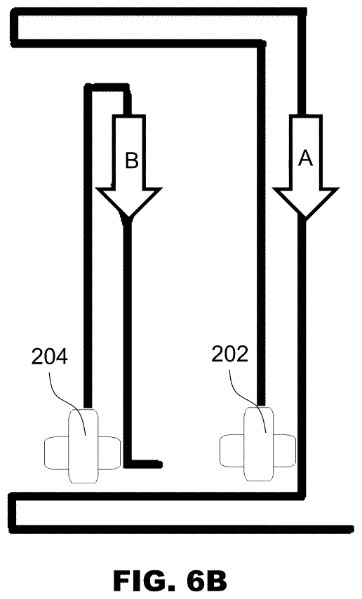

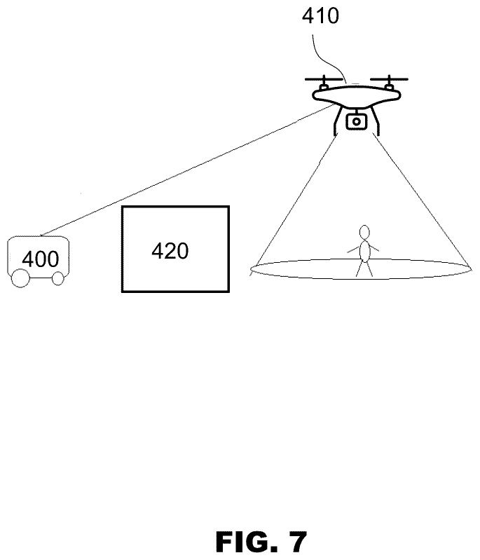

In some embodiments, when a human operates one vehicle of a flock manually, the human may be in front of the flock, in the middle, or slightly behind it. In some embodiments, such as the one shown in FIG. 6A and FIG. 6B, the position and heading of the manual vehicle can be compared to the position and heading of the follower vehicles in the flock. In some embodiments, this position and/or heading can be used to determine if the human is too far in front of flock. For example, in some embodiments, if the human is more than a given distance (such as 30 meters in front of the flock) this can present a safety concern. In some embodiments, this position and/or heading can be used to determine if the human has a direct line-of-sight to detect people, animals, and small objects directly in front of the other vehicles in the flock. In some embodiments, this position and/or heading can be used to determine how many seconds passed since the last time the human had a direct line-of-sight to the area in front of the flock. For example, in some embodiments, it may be acceptable to allow the flock to operate autonomously for a given time, such as several seconds, even when the human operator does not have direct line of sight. In some embodiments, after a given time, the autonomous vehicles in the flock can be commanded to stop. In some embodiments, this method allows a human to perform other side-tasks while statistically minimizing the chances of people or animals approaching the autonomous vehicles without being noticed by the human.

For example, FIG. 6A and FIG. 6B show possible paths (path A and Path B) of leader vehicle 202 and follower vehicle 204. In some embodiments of the example shown in FIG. 6A, takes the same amount of time (for example one minute) for both vehicles to complete their respective paths. In FIG. 6A and FIG. 6B follower vehicle 204 is an autonomous vehicle and leader vehicle 202 is a manual (human-operated) vehicle. In at least some embodiments, leader vehicle 202 is slightly faster than follower vehicle 204 and can accomplish additional mowing at the worksite while maximizing, or at least increasing, the time the operator has direct line-of-sight to the area in front of follower vehicle 204. FIG. 6B shows the vehicles at a later time.

In some embodiments, to estimate the position and/or heading of leader vehicle 202 it can be equipped with a GNSS RTK antenna and/or a regular GPS antenna (non RTK). In some embodiments, the position and/or heading of leader vehicle 202 can also be estimated using the GPS located in the phone of the human operator.

If a physical connection is used between the leader vehicle and the follower vehicle, then the dead-man switch of the follower vehicle can be controlled by the leader vehicle. In some of these embodiments, a physical disconnect between the leader vehicle and follower vehicle makes the follower vehicle stop.

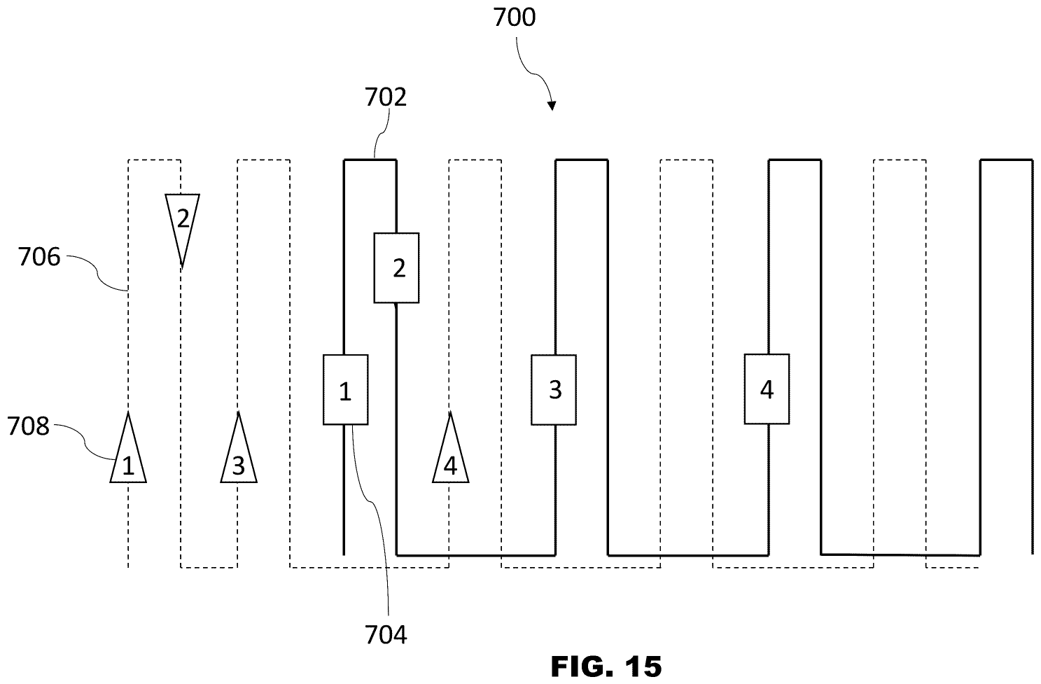

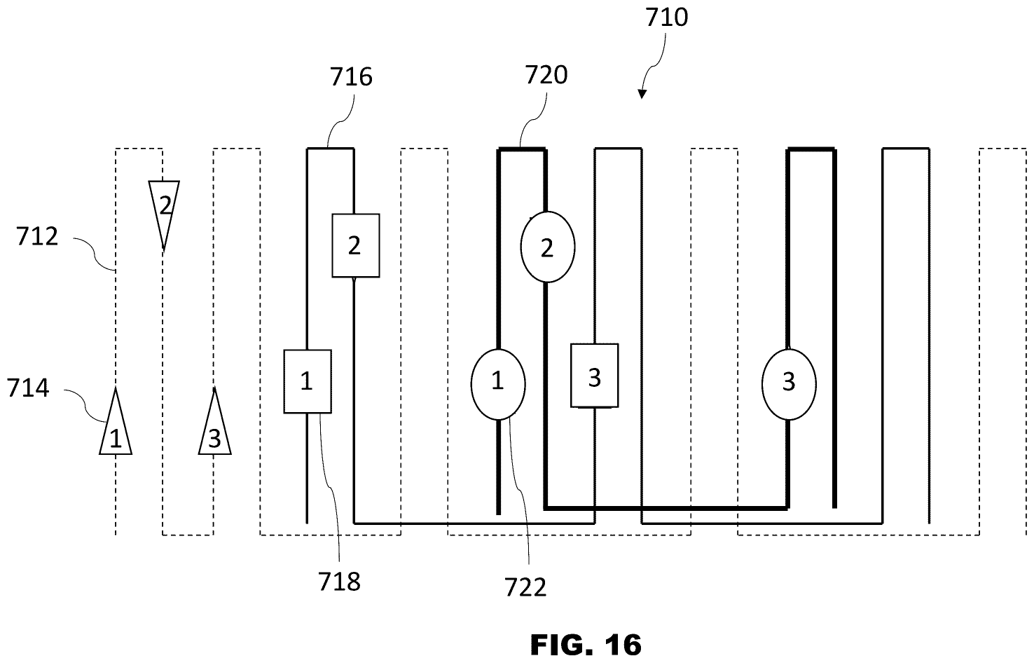

In some embodiments, a flock of vehicles can be configured to follow a planned path. For example, FIG. 15 and FIG. 16 show possible planned paths for a flock of vehicles.

In some embodiments, as shown in FIG. 15, planned path 700 includes path 702 for leader vehicle 704 and path 706 for follower vehicle 708. In some embodiments leader vehicle 704 is an autonomous vehicle and follower vehicle 708 is a manual vehicle. In some embodiments, manual follower vehicle 708 can move autonomously, but an operator can be present in/on vehicle 708 to supervise and for safety purposes. For illustrative purposes, FIG. 15 shows path 702 of autonomous leader vehicle 704 with a solid line and path 706 of manual follower vehicle 708 with a broken line. Additionally, for illustrative purposes, leader vehicle 704 is shown as a square with a number within it and follower vehicle 708 is shown as a triangle with a number within it. The numbers within the shapes are used to illustrate the location of leader vehicle 704 and follower vehicle 708 with respect to one another at four different moments in time.

In some embodiments, vehicles 704 and 708 are mowers. In some embodiments, as shown in FIG. 15, autonomous leader vehicle 704 can be configured to create lanes for manual follower vehicle 708 to fill in. In some embodiments, autonomous leader vehicle 704 can begin mowing at a location to the side of manual follower vehicle 708. In some embodiments, autonomous leader vehicle can begin mowing at a location to the side of manual follower vehicle 708 and in a position ahead of manual follower vehicle 708. In some embodiments, autonomous leader vehicle 704 can begin mowing before manual follower vehicle 708 begins mowing such that autonomous leader vehicle 704 is located to the side of and positioned ahead of follower vehicle 708. By locating and positioning autonomous leader vehicle 704 and manual follower vehicle 708 as described, an operator/supervisor in the manual follower vehicle 708 can see the area in front of the manual follower vehicle 708, autonomous leader vehicle 704, and the area in front of autonomous leader vehicle 704.

In some embodiments, after the first two lanes, the typical distance between manual follower vehicle 708 and autonomous leader vehicle 704 is larger than three lanes. For example, if the width of a lane 1.7 m, then there are more than 5 m between the vehicles 704 and 708. By distancing manual follower vehicle 708 and autonomous leader vehicle 704 as described, a supervisor can see the autonomous leader vehicle, the chance of an accidental collision is reduced, and dust created by the leader vehicle 704 is less likely to reach follower vehicle 708. Additionally, the supervisor can examine the work performed by the autonomous leader vehicle and make manual corrections/patching to errors in the area.

In some embodiments, such as shown in FIG. 16, planned path 710 includes path 712 for a manual vehicle 714, path 716 for a first autonomous vehicle 718, and path 720 for second autonomous vehicle 722. In some embodiments, manual vehicle 714 can move autonomously, but an operator can be present in/on vehicle 714 to supervise and for safety purposes. For illustrative purposes, FIG. 16 shows path 712 of manual vehicle 714 with a broken line, path 716 of first autonomous vehicle 718 with a solid line, and path 720 of second autonomous vehicle 722 with a bolded solid line. For illustrative purposes, manual vehicle 714 is shown as a triangle with a number within it, first autonomous vehicle 718 is shown as a square with a number within it, and second autonomous vehicle 722 is shown as an oval with a number within it. The numbers within the shapes are used to illustrate the location of manual vehicle 714, first autonomous vehicle 718, and second autonomous vehicle 722 with respect to one another at three different moments in time.

In some embodiments, manual vehicle 714, first autonomous vehicle 718, and second autonomous vehicle 722 are mowers. In some embodiments, first autonomous vehicle 718 and second autonomous vehicle 722 are configured to mow in a path to leave an unfinished lane between a lane mowed by first autonomous vehicle 718 and a lane mowed by second autonomous vehicle 722. By leaving an unfinished lane between the lanes mowed by first autonomous vehicle 718 and second autonomous vehicle 722, a supervisor on/in manual vehicle 714 can examine the work done by first autonomous vehicle 718 and second autonomous vehicle 722 and make any corrections necessary. In some embodiments, manual vehicle 714 is located to the side of and at a position behind first autonomous vehicle 718 and second autonomous vehicle 722. In some embodiments, first autonomous vehicle 718 and second autonomous vehicle 722 can begin mowing before manual vehicle 714. By distancing and positioning manual vehicle 714 and first autonomous vehicle 718 and second autonomous vehicle 722 as described, a supervisor can see first autonomous vehicle 718 and second autonomous vehicle 722, the chance of an accidental collision is reduced, and dust created by first autonomous vehicle 718 and second autonomous vehicle 722 is less likely to reach manual vehicle 714.

Coupling Vehicles with Drones

In some embodiments, vehicle 400 can be connected to drone 410. In some embodiments, vehicle 400 is physically connected to at least one drone 410 via a physical cord. In some embodiments, vehicle 400 is wirelessly connected to drone 410. In some embodiments, vehicle 400 is a leader vehicle in a flock of vehicles such as flock 200 described above. In some embodiments, vehicle 400 is a follower vehicle in a flock of vehicles as described above.

In some embodiments, drone 410 is configured to hover above vehicle 400 to help detect obstacles and/or dangers. In some embodiments, drone 410 can hover a given distance (such as several meters) above vehicle 400. In some embodiments, drone 410 adjusts its hovering height based on obstacles such as trees.

In some embodiments, drone 410 flies in front of vehicle 400 and scans the area in front of vehicle 400 before vehicle 400 gets there. In some embodiments, drone 410 is equipped with scanners and/or cameras. In some embodiments, drone 410 is equipped with long wave/thermal cameras “LWIR” and/or RGB cameras to detect objects, such as but not limited to, people and animals, using a bird's-eye view. In at least some embodiments, a bird's-eye view is more effective in detecting objects hidden in tall grass than on-board sensors on vehicle 400. In at least some embodiments, drone 410 is able to see behind obstacles, such as buildings and trees, before any sensors and/or cameras on vehicle 400 would be able to see behind obstacle 420.

In some embodiments, drone 410 can be powered by vehicle 400. In some embodiments, drone 410 is able to land on vehicle 400 to charge. In some embodiments the position of drone 410 can be estimated and controlled using on-board sensors on vehicle 400. In some embodiments, on-board sensors on vehicle 400 can help prevent, or at least reduce the chance of, drone 410 colliding with other obstacles such as tree branches and buildings.

### Vehicles Using Safety Wire

Slow-moving autonomous vehicles are often equipped with safety bumpers. These bumpers are typically effective at low operating speeds (for example under 2 mph). At these low speeds, the stopping distances are often small (in the range of 10-20 cm). When stopping distances are small, the vehicle can stop without causing damage to obstacles and without damaging the safety bumper.

When dealing with heavy machines that operate at higher speeds, such as 10 mph, stopping distances are significantly higher, and can be in the range of 1 meter. Although it is possible to design safety bumpers capable of compressing by 1 meter during an impact, such designs are expensive and unpractical.

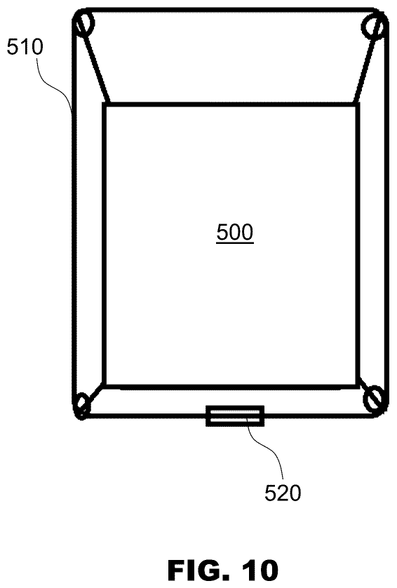

One possible solution is the use of a safety wire positioned around the vehicle. In some embodiments, such as shown in FIG. 10, vehicle 500 is equipped with safety wire 510. In some embodiments, vehicle 500 is a leader vehicle in a flock of vehicles as described above. In some embodiments, vehicle 500 is a follower vehicle in a flock of vehicles as described above. In some embodiments, safety wire 510 is detachable. In some embodiments, such as the one shown in FIG. 5, safety wire 510 stretches around vehicle 500.

In some embodiments, safety wire 510 conducts a small current and is connected directly to a dead-man-switch of the vehicle. In some embodiments, magnet 520 holds safety wire 510 in place. In at least some embodiments, if vehicle 500 hits an obstacle, magnet 520 separates, the current in safety wire 510 stops flowing, and vehicle 500 comes to a stop.

In some embodiments, to detect loss of tension in the safety wire 510, it is possible to install a cable-pull safety switch around the vehicle 500, in conjunction with the magnetic disconnect.

In some embodiments, to reduce the space taken by vehicle 500 when it is not in use and/or being transported, safety wire 510 can be manual or electronically folded to reduce space.

Safety wire 510 offers several advantages over traditional bumpers including but not limited to, detecting tiny obstacles in tall grass, such as raised sprinkler heads; having the ability to detach from vehicle 500 during a collision and prevent damage to the obstacle and/or vehicle 500; allowing vehicle 500 to stop even at high operating speeds (assuming safety wire 510 extends sufficiently out past the front of vehicle 500); and/or being less expensive than installing safety bumpers around a vehicle.

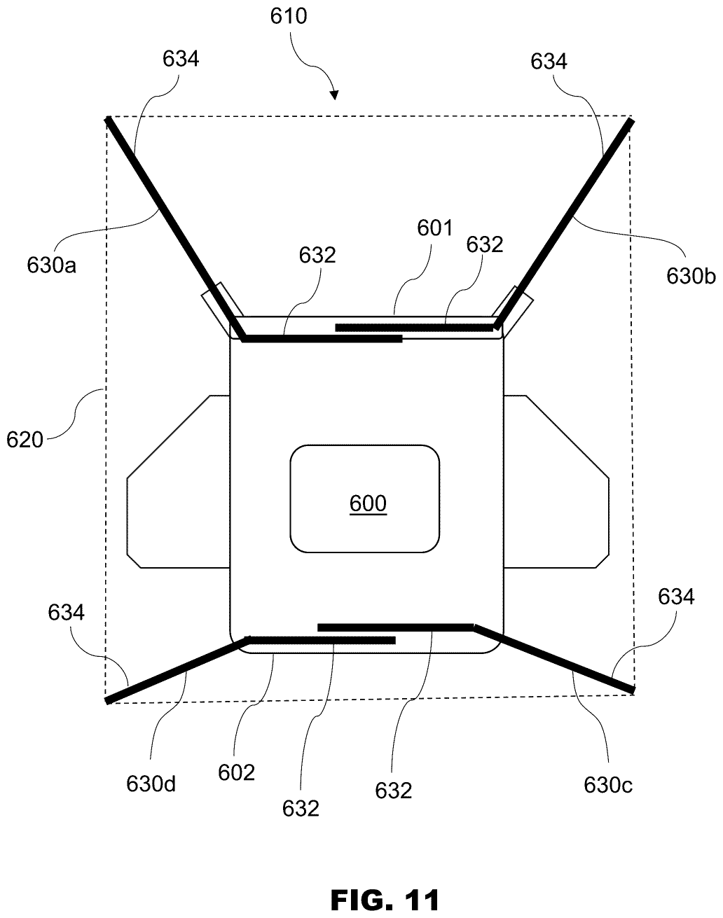

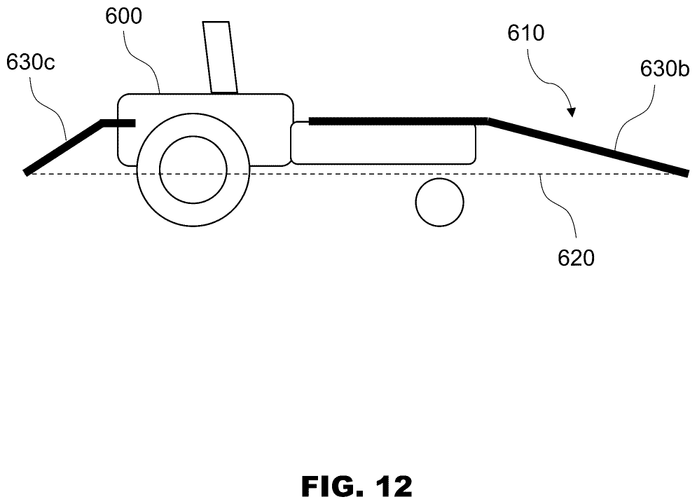

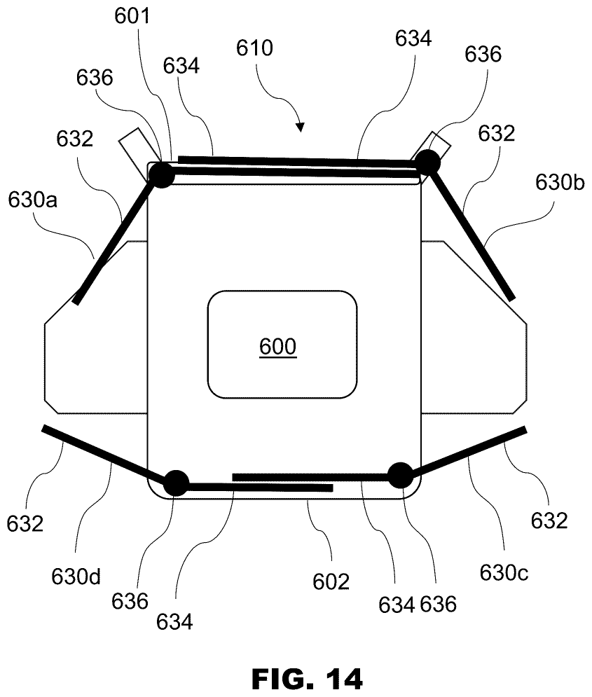

Another possible solution is the use of a retractable/disconnect-able bumper system. In some embodiments, such as shown in FIGS. 11-14, vehicle 600 is equipped with a retractable/disconnect-able bumper system 610. In some embodiments, retractable/disconnect-able bumper system 610 includes safety wire 620 and bumper arm 630a, bumper arm 630b, bumper arm 630c, and/or bumper arm 630d. In some embodiments, at least one of bumper arm 630a, bumper arm 630b, bumper arm 630c, and/or bumper arm 630d can be rotatable. In some embodiments, bumper arm 630a, bumper arm 630b, bumper arm 630c, and/or bumper arm 630d can be disconnect-able or removable from vehicle 600. In some embodiments, vehicle 600 is a leader vehicle in a flock of vehicles as described above. In some embodiments, vehicle 600 is a follower vehicle in a flock of vehicles as described above.

In some embodiments, such as the one shown in FIG. 11, safety wire 620 can be attached to the ends of bumper arm 630a, bumper arm 630b, bumper arm 630c, and/or bumper arm 630d and stretches around vehicle 600. In some embodiments, safety wire 620 can be a low-weight, high-strength non-stretchable wire. In some embodiments, safety wire 620 can be a strong metal fishing line or similar strong conductive material. In some embodiments, safety wire 620 acts as a “trip wire” and disconnects upon impact with an object.

In some embodiments, bumper arm 630a, bumper arm 630b, bumper arm 630c, and/or bumper arm 630d can be angled and include a short arm portion 632 and a long arm portion 634. In some embodiments, such as the one shown in FIG. 11, in a deployed/connected configuration, short arm portions 632 can be parallel to either front end 601 and back end 602 of vehicle 600 and are located within the perimeter defined by vehicle 600. In some embodiments, long arm portions 634 extend away at an angle from short arm portions 632 beyond the perimeter defined by vehicle 600. In some embodiments, safety wire 620 can be attached to the ends of long arm portions 634 to define a bumper perimeter.

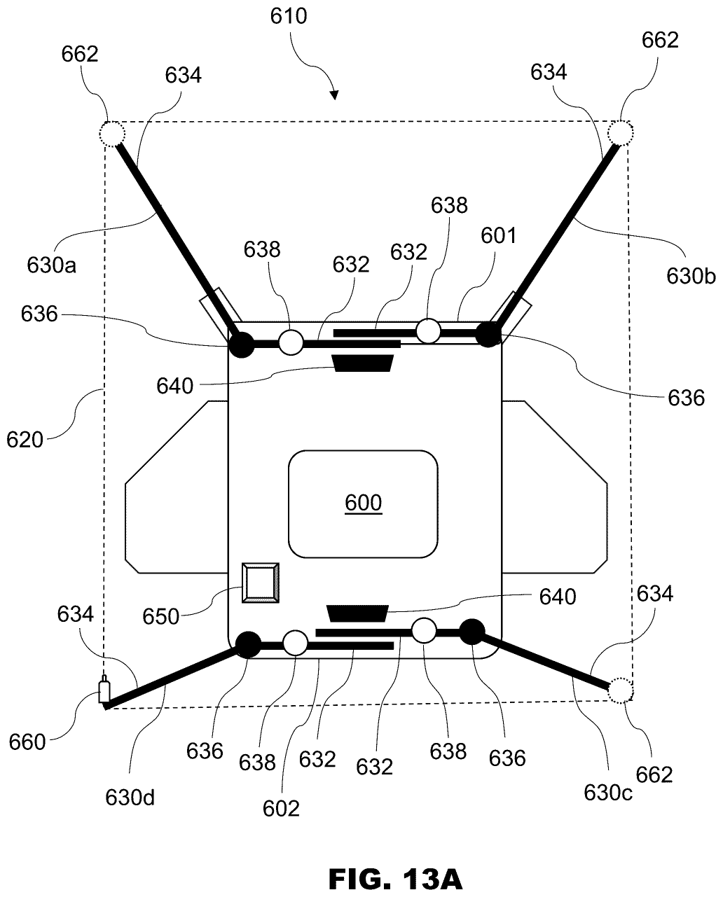

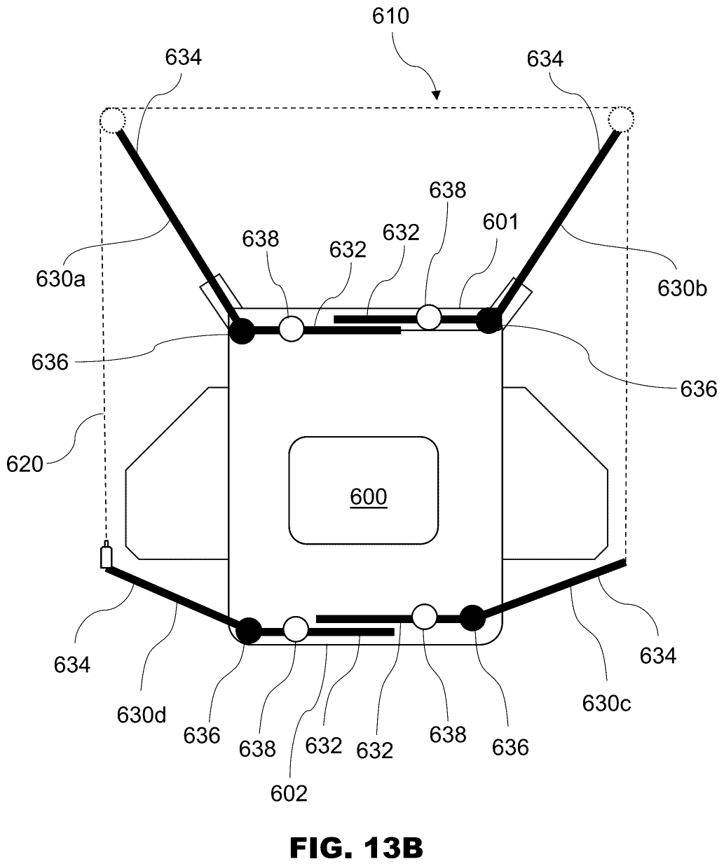

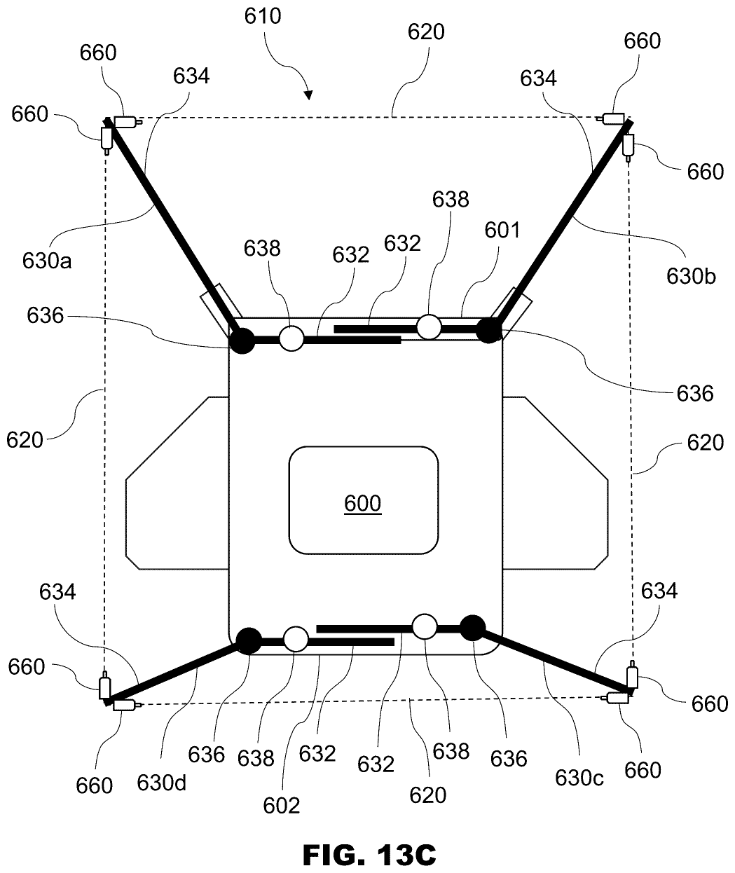

In some embodiments, bumper system 610 can include a variety of components and can have a variety of deployed configurations, as shown in FIGS. 13A-C. In some embodiments, bumper arm 630a, bumper arm 630b, bumper arm 630c, and/or bumper arm 630d can pivot at the vertex of the angle defined by short arm portion 632 and long arm portion 634 of bumper arm 630a, bumper arm 630b, bumper arm 630c, and/or bumper arm 630d. In some embodiments, bumper arm 630a, bumper arm 630b, bumper arm 630c, and/or bumper arm 630d are attached to vehicle 600 at the vertex of bumper arm 630a, bumper arm 630b, bumper arm 630c, and/or bumper arm 630d with a metal rod 636 configured to allow the bumper arm 630a, bumper arm 630b, bumper arm 630c, and/or bumper arm 630d to pivot at the vertex. In some embodiments, metal rod 636 is a bolt including a portion with no threads on it. In some embodiments, bumper arm 630a, bumper arm 630b, bumper arm 630c, and/or bumper arm 630d can be locked into place using quick-disconnect bolt 638. In some embodiments, quick-disconnect bolt 638 can lock short arm portion 632 to vehicle 600 to restrict rotation of bumper arm 630a, bumper arm 630b, bumper arm 630c, and/or bumper arm 630d. In some embodiments, quick-disconnect bolt 638 can be configured to disconnect quickly when force is applied from a collision with an object or by a user folding away the bumper. In some embodiments, quick-disconnect bolt 638 can be a breakable plastic bolt and nut that can be cheaply replaced after a force disconnects bumper system 610. In some embodiments, quick-disconnect bolt 638 can be a spring-loaded ball-socket locking bolt. In some embodiments, quick-disconnect bolt 638 can be a quick release pin.

In some embodiments, bumper system 610 can include a safety switch. In some embodiments, bumper system 610 can include multiple safety switches 640. In some embodiments, bumper system 610 includes a safety switch located near front end 601 and back end 602 of vehicle 600. In some embodiments, safety switch 640 can be a safety-rated proximity switch that senses the impact to bumper arm 630a, bumper arm 630b, bumper arm 630c, and/or bumper arm 630d. In some embodiments, short arm portions 632 of bumper arms located at the same end of vehicle 600 sit on top of one another and the proximity switch is coupled to each short arm portion 632. For example, short arm portions 632 of bumper arm 630a and bumper arm 630b sit on top of one another and are coupled to a safety switch 640 located at or near the front end 601 of vehicle 600. Additionally, short arm portions 632 of bumper arm 630c and bumper arm 630d sit on top of one another and are coupled to safety switch 640 located at or near back end 602 of vehicle 600. In some embodiments, when safety switch 640 senses that bumper arm 630a, bumper arm 630b, bumper arm 630c, and/or bumper arm 630d has been disconnected, vehicle 600 stops.

In some embodiments, bumper system 610 can include electronic control unit 650. In some embodiments, electronic control unit 650 is included on vehicle 600. In some embodiments, electronic control unit 650 measures the voltage within safety wire 620 and detects if safety wire 620 is broken or disconnected.

Safety wire 620 can be connected to the control unit 650 in a variety of ways. For instance, in some embodiments, one side of safety wire 620 can be connected to a constant ground signal (i.e., negative terminal of battery power). The other side of the safety wire 620 can be connected to a digital input pin of electronic control unit 650. The digital pin is “pulled up” (pulled high), which means it reads a logic value of “1” whenever there is nothing connected to it. Whenever the digital input pin is connected to ground using the safety wire 620, the digital input pin reads a logic value of “0.” When the safety wire 620 becomes disconnected, the circuit breaks, which is detected by the electronic control unit 650. The electronic control unit 650 then commands the vehicle 600 to stop.

In some embodiments, vehicle 600 is an electric commercial mower that utilizes regenerative braking to slow down. In some embodiments, the safety wire 620 can drive a solid-state relay that controls power to a battery management system (BMS). In some embodiments, when the safety wire 620 is disconnected, power to the BMS can be turned off, causing the wheels to actively lock (for, example, by applying the brakes) and reduce the stopping distance.

In some embodiments, the electronic control unit can be directly connected to another safety feature, such as a dead-man switch or lap-bar switch. In some embodiments, safety wire 620 completes the physical circuits for the lap-bar and/or dead-man switch.

In some embodiments, voltage sent through safety wire 620 can be low and the safety wire is fused. In some embodiments, a fuse can be connected in series with the safety wire 620 to protect it from allowing too much current to flow through it in case it comes into contact with another conductive material with a different voltage level.

Bumper system 610 can include some or all of the features described herein and can be placed in a variety of configurations. In some embodiments, bumper system 610 can include a variety of deployed configurations as shown in FIGS. 13A-13B.

In some embodiments, a spring-loaded trip wire switch 660 can be attached to the end of long arm portion 634 of one of the bumper arm 630a, bumper arm 630b, bumper arm 630c, and/or bumper arm 630d. The safety wire 620 can be attached to trip wire switch 660. In some embodiments, bumper system 610 can include trip wire switch 660 and a plurality of pulleys 662 to attach safety wire 620 to bumper system 610.

For example, FIG. 13A shows trip wire switch 660 located at the end of long arm portion 634 of bumper arm 630d. Pulleys 662 can be located at the ends of long arm portion 634 of bumper arm 630a, bumper arm 630b, and/or bumper arm 630c. It shall be understood that the trip wire switch 660 can be attached to any of bumper arm 630a, bumper arm 630b, bumper arm 630c, and/or bumper arm 630d and the remaining bumper arms can include a pulley 662 without departing from the scope of the disclosure. In some embodiments, pulleys 662 can be enclosed in a protective case. In some embodiments, as shown in FIG. 13A, a first end of safety wire 620 can be attached to trip wire switch 660 and held by pulleys 662 around vehicle 600. In some embodiments, the second end of safety wire 620 can be attached to the end of long arm portion 634 of bumper arm 630d.

In some embodiments, such as shown in FIG. 13B, safety wire 620 is stretched along the sides and front end of vehicle 600, such that safety wire 620 does not stretch along back end 602 of vehicle 600. In some embodiments, the bumper arms located at or near back end 602 of vehicle 600 (for example, bumper arm 630c and bumper arm 630d in FIG. 13B) include long arm portions 634 angled towards the front end 601 of vehicle 600. In some embodiments, trip wire switch 660 is located on bumper arm 630d and pulleys 662 are located on bumper arm 630a and bumper arm 630b. In some embodiments, bumper system 610 includes a safety-rated pull rope switch or a magnet instead of a trip wire switch. In some embodiments, safety wire 620 is attached to trip wire switch 660 on bumper arm 630d, stretched and held around pulleys 662 on bumper arm 630a and bumper arm 630b, and attached to the end of bumper arm 630c.

In some embodiments, such as shown in FIG. 13C, bumper system 610 includes a plurality of trip wire switches 660 and a plurality of segments of safety wire 620. In some embodiments, each bumper arm includes one trip wire switch 660, such that a segment of safety wire 620 is connected at one end to a trip wire switch 660 on one bumper arm and at another end directly to a subsequent bumper arm. For example, one end of a segment of safety wire 620 can be attached to a trip wire switch 660 on bumper arm 630a and the other end of safety wire 620 can be directly attached to bumper arm 630b. A similar configuration can be used to surround vehicle 600 with segments of safety wire 620, such that a segment of safety wire 620 extends between bumper arm 630b and bumper arm 630c, bumper arm 630c and bumper arm 630d, and bumper arm 630d and bumper arm 630a. In some embodiments, each bumper arm includes two trip wire switches 660, such that a segment of safety wire 620 is connected at each end to trip wire switches 660 on different bumper arms. For example, as shown in FIG. 13C, a segment of safety wire 620 is connected at one end to a trip wire switch 660 on bumper arm 630a and at another end to a trip wire switch 660 on bumper arm 630b. A similar configuration can be used to surround vehicle 600 with segments of safety wire 620, such that a segment of safety wire 620 is extended between bumper arm 630b and bumper arm 630c, bumper arm 630c and bumper arm 630d, and bumper arm 630d and bumper arm 630a. Connecting each end of a segment of safety wire 620 to trip wire switch 660 can reduce the occurrence of false positives.

In some embodiments, retractable/disconnect-able bumper system 610 can be placed in a folded/stored configuration. In some embodiments, to place the bumper system 610 in a folded configuration, safety wire 620 could be removed and bumper arm 630a, bumper arm 630b, bumper arm 630c, and/or bumper arm 630d can be rotated until long arm portions 634 are parallel with front end 601 and back end 602 of vehicle 600. In some embodiments, quick-disconnect bolts 638 can be removed or broken before rotating bumper arm 630a, bumper arm 630b, bumper arm 630c, and/or bumper arm 630d. In some embodiments, bumper system 610 can be placed in a folded configuration to transport vehicle 600 or when vehicle 600 is operating in tight spaces. In some embodiments, bumper arm 630a, bumper arm 630b, bumper arm 630c, and/or bumper arm 630d are coupled to electrical motors configured to move bumper arm 630a, bumper arm 630b, bumper arm 630c, and/or bumper arm 630d from a folded configuration to a deployed configuration and vice versa. In some embodiments, bumper arms 630a-d can be removed from vehicle 600.

Bumper system 610 offers several advantages over traditional bumper systems. In some embodiments, the low-weight safety wire 620 requires a low activation force to disconnect it, but it is also not sensitive to vibrations and can be placed far from vehicle 600 to allow for detection of collision before vehicle 600 collides with an object. Accordingly, this allows for a large stopping distance and minimization of the occurrence of false positives. Additionally, bumper system 610 can be configured to detect small objects hidden in tall grass (such as a stump or a rock). In some embodiments, bumper system 610 is not affected by dust, rain, or temporary obstructions like birds. In at least some embodiments, bumper system 610 is configured such that it is unlikely to be disabled and/or degraded by cyber-attacks.

In some embodiments, a User Interface can allow a single user to adjust features on all the mowers in the flock. In some embodiments, the virtual coupling of mowers allows a single user to control the ground speed of all mowers by simply controlling the speed of the manual mower. In some embodiments, this is useful for dynamically adjusting the speed of the mower based on the height of the grass.

In some embodiments, the user can also control things like blade speed and/or cutting-deck height on at least one, if not all, autonomous mowers by simply setting the correct values on the manual mower.

Object Detection

In at least some embodiments, unexpected objects can present themselves at a given worksite. For example, in some embodiments, the unexpected object can be a ball, a large stick, a rock, a piece of trash, or an injured animal. In some instances, not avoiding these objects can damage the autonomous vehicle, such as ruining the blade of a lawnmower. In at least some embodiments, autonomous guidance system 1000 can be configured to detect these items and either stop before running into them and/or adjust its course to avoid them.

In some embodiments, autonomous guidance system 1000 can return the vehicle to the area of the unexpected object at a later time to determine if it is now safe to mow, fertilize, plow, etc. In at least some embodiments, autonomous guidance system 1000 sends an alert to a user to check the location in which the unexpected object was present.

In at least some embodiments, autonomous guidance system 1000 utilizes data from a pre-generated map to determine if the object is unexpected. In some embodiments, data from a pre-generated map, for example the presence of nearby trees, can be used to predict the likelihood that the unexpected object is a leaf.

In at least some embodiments, the size of the unexpected object plays a role in determining whether the autonomous vehicle should stop and/or avoid the unexpected object. In at least some embodiments, any object larger than a couple of inches in width and/or height can trigger autonomous vehicle to stop and/or avoid it. In some embodiments, unexpected objects that move can be avoided. For example, in some embodiments the system can distinguish between unexpected objects that do not need to be avoided (such as leaves blowing in the wind) and objects that should be avoided such as animals. In some embodiments, this is accomplished via artificial intelligence analyzing the motion captured by cameras and/or Lidars. In some embodiments, the system uses an infrared camera to predict whether an object is alive.

In at least some embodiments, unexpected objects can be detected, and their sizes can be computed, through analysis of vertical and horizontal jumps in the point cloud data.

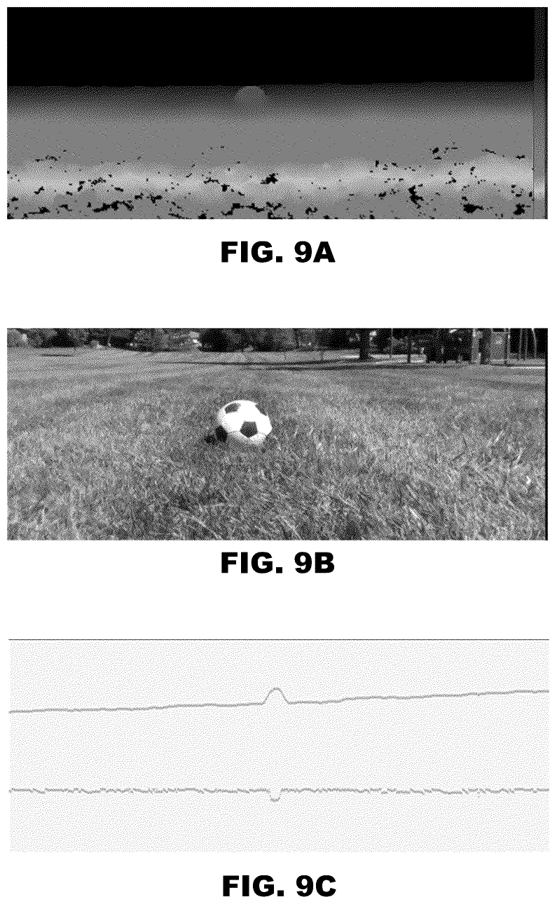

In some embodiments, data from an infrared sensor can be compared with data from a RGB image originating from a camera. See for example FIG. 9A and FIG. 9B. In some embodiments, this data can be used to conduct a vertical analysis of the point cloud data such as shown in FIG. 9C. In some embodiments, the autonomous guidance system 1000 can be configured to detect spikes in the data and identify them as unexpected objects. In some embodiments, autonomous guidance system 1000 ignores spikes less than a given percentage. In some embodiments, these smaller spikes can correspond to a large leaf, a pile of leaves, and/or tall grass.

In some embodiments, the below analysis can be performed with point cloud data originating from an IR depth camera or from a Lidar. In some embodiments, the system loops through each row in the depth data from left to right (or from right to left). For each row, the system loops through each column in the depth data from top to bottom (or bottom to top).

The system then determines the depth in current pixel (distance from camera to the pixel) and compares it to the depth of the previous pixel. In this example, the previous pixel is the pixel immediately to the left of the current pixel. If there is a significant difference between the depth of the current pixel and the depth of the previous pixel, then the system determines there is a possible unexpected object in this location. In some embodiments, the threshold difference is at least 0.25 m. In some embodiments, the threshold difference is at least 0.2 m.

By way of example, for a camera mounted to a lawnmower about a foot off the ground and pointing straight, it is normal to see depth jumps of 0.2 m or lower. These are typical depth jumps between adjacent individual grass pieces. In some cases, especially when dealing with tall grass, this threshold can be as high as 1.0 m. In some embodiments, the threshold used can be dynamically determined by running the mower for a short distance on a section of the field where the grass is tall. In some embodiments, this can be done automatically at each start. In some embodiments, to decide on whether an object is truly present in the frame, the size of the object can be computed using its boundary (the rows and columns where the object started and ended) and using information about the camera's lens geometry. For example, if the height of the object exceeds a given height and/or width (e.g., 2 inches), then it is likely to be a real object. In some embodiments, the system treats possible objects that fall under a given threshold as noise.

In some embodiments where RGB data from camera is present, its pixel values can be correlated to the depth data at the location of the object to check whether the objects color is significantly different from the area surrounding it, such as grass. This can add another level of certainty to whether an object is present and can be considered by the autonomous guidance system 1000.

In some embodiments, autonomous guidance system 1000 can run the RGB image of the object through an AI model to determine whether this object is likely to be something like a leaf, which can be safely ignored, or whether it is something like a rock which can damage the blade.

The analysis described above is a horizontal pixel analysis. Similar analyses can be performed vertically by comparing the current pixel value to the one right above it and computing vertical jumps in the distance.

The results from both the horizontal and vertical analyses help create a more reliable conclusion on the presence of unexpected objects and their dimensions.

In some embodiments, data from a camera can be used by autonomous guidance system 1000 to identify the unexpected object. In some embodiments, this identification is accomplished by comparing the image of the unexpected object with a database of preidentified objects, such as balls, leaves, sticks, rocks, and the like.

In some embodiments, data regarding the unexpected object can be sent to an operator. In some embodiments, the operator can be on site. In some embodiments, the data is accessed via a mobile device such as a smart phone, computer, tablet, or the like. In some embodiments, the information is sent via a wireless signal. In some embodiments, the autonomous vehicle can transmit signals via one of several wireless communications protocols, such as Bluetooth, Wi-Fi, CDMA, 900 MHz, 3G/4G/5G/Cellular, near-field communication, and/or other communication protocol to a network and/or directly to a mobile device.

In some embodiments, when an unexpected object is detected, the autonomous vehicle comes to a stop and the operator can be alerted. In some embodiments, the operator is shown an image of the unexpected object on a mobile device. In some embodiments, the operator then has a choice: either to go to the vehicle and remove the unexpected object or to click a button on the mobile device to ignore the object and allow the vehicle to continue to move forward and/or move around the object. For example, when the unexpected object is a leaf or some tall weeds, the operator can choose to ignore the unexpected object and allow the vehicle to continue forward. In some embodiments, the operator's decision, along with an image of the unexpected object, are then saved on a remote server. In some embodiments, the data in the server is then periodically analyzed to generate a machine-learning model (ML) which determines which unexpected objects should require the vehicle to stop and which objects can be ignored. In at least some embodiments, autonomous guidance system 1000 can also utilize data from a pre-generated map to determine if the object is unexpected. In some embodiments, data from a pre-generated map, for example the presence of nearby trees, can be used to predict the likelihood the unexpected object is a leaf. In at least some embodiments, the ML model correctly recognizes small objects, such as leaves and weeds, which should be ignored by the autonomous vehicle.

In some embodiments, the maximum speed of the vehicle is controlled by its distance to the nearest obstacle. For example, in some embodiments, when a vehicle gets closer to trees and buildings, it slows down. In some embodiments, as the vehicle gets close to the perimeter of the worksite, it slows down. In some embodiments, if a vehicle leaves the perimeter of a predetermined worksite, it stops.

In some embodiments, where a worksite perimeter has been established, a vehicle can stop if it detects an object in the worksite and the object is close enough to the vehicle and it is a living thing (human or animal). In some embodiments to detect if something is living, vehicle vision algorithms analyze data from RGB cameras, LWIR cameras, lidar sensors, or radar sensors.

In some embodiments, where a worksite perimeter has been established, a vehicle can stop if it detects an object in the worksite, the object is close enough to the vehicle, and the object is not “map-matched” to an existing object on the map. In some embodiments, map-matching is done by comparing the sizes and positions of objects that were present during a mapping operation to the sizes and positions of objects detected during the autonomous run.

In some embodiments, when a vehicle detects an object located outside the perimeter of the worksite, it stops only if the object is a living thing and is sufficiently close to the vehicle. In other words, in some embodiments, the vehicle allows objects to change outside the perimeter of a worksite and it ignores them as long as they are not living things.

In some embodiments, the vehicle employs logic that enables effective map-matching while also enabling autonomous operations. For example, the logic can be used to allow the vehicle to operate near a road (where moving cars cannot be map-matched), near a parking lot (where cars can change position from one day to the next), and/or near a farm field (where crops can grow significantly overtime).

While particular elements, embodiments and applications of the present invention have been shown and described, it will be understood, that the invention is not limited thereto since modifications can be made by those skilled in the art without departing from the scope of the present disclosure, particularly in light of the foregoing teachings.

What is claimed is:

1. A flock of vehicles, wherein said flock comprises:
a first leader vehicle; and
a first follower vehicle,
wherein said first leader vehicle and said first follower vehicle are coupled together.

2. The flock of vehicles of claim 1 wherein said first leader vehicle is a first lawnmower and said first follower vehicle is a second lawnmower.

3. The flock of vehicles of claim 1 wherein said first leader vehicle includes a first sensor.

4. The flock of vehicles of claim 1 further comprising
a second follower vehicle;
a third follower vehicle; and
a fourth follower vehicle.

5. The flock of vehicles of claim 4 wherein said flock of vehicles are configured to be operated in an inverted V-shape configuration.

6. The flock of vehicles of claim 4 wherein said flock of vehicles are configured to be operated in a W-shape configuration.

7. The flock of vehicles of claim 1 wherein said first leader vehicle is connected to said first follower vehicle via a retractable cable.

8. The flock of vehicles of claim 3 wherein said first sensor is used to detect a unique feature on said first follower vehicle.

9. The flock of vehicles of claim 1 wherein said flock is configured to detect an individual using a UHF RFID tag.

10. A system comprising:
an autonomous vehicle; and
a drone coupled to said autonomous vehicle.

11. The system of claim 10 wherein said drone is physically connected to said autonomous vehicle via a physical cord.

12. The system of claim 10 wherein said drone is connected to said autonomous vehicle via a wireless connection.

13. The system of claim 10 further comprising:
a second vehicle, wherein said autonomous vehicle and said second vehicle form a flock.

14. The system of claim 10 wherein said drone hovers above said autonomous vehicle and said drone is configured to detect an obstacle.

15. The system of claim 10 wherein said drone hovers in front of said autonomous vehicle and said drone is configured to detect an obstacle.

16. The system of claim 10 wherein said drone has a camera.

17. The system of claim 15 wherein said autonomous vehicle is a lawnmower.

18. An autonomous vehicle comprising a safety wire configured to stretch around said autonomous vehicle.

19. The autonomous vehicle of claim 18 wherein said safety wire conducts a current and is connected to a dead-man switch on said autonomous vehicle, wherein said safety wire is held together via a magnet.

20. The autonomous vehicle of claim 19 wherein said safety wire is configured to be electronically folded to reduce space.
